(19) United States
(12) Patent Application Publication
(10) Pub. No.: US 2017/0138378 A1
(43) Pub. Date: May 18, 2017

(54) MAGNETIC GARMENT HANGER ASSEMBLY

(71) Applicant: Chris Davidson, Roseburg, OR (US)

(72) Inventor: Chris Davidson, Roseburg, OR (US)

(21) Appl. No.: 15/351,278

(22) Filed: Nov. 14, 2016

Related U.S. Application Data
(60) Provisional application No. 62/255,047, filed on Nov. 13, 2015.

(51) Int. Cl. F16B 1/00; A47G 33/00; F16M 13/02

(52) U.S. Cl. CPC F16B 1/00; F16M 13/02; A47G 33/004; F16B 2001/0035

(57) ABSTRACT

Magnetic garment hanger assemblies for securing articles or garments are disclosed. The magnetic hanger assemblies disclosed herein include a garment casing that attaches to a wall member having a magnetic surface and mounted to a mounting surface. The garment casing or wall member may be configured with one or more grooves for retaining at least one magnet. A garment may be secured between the garment casing and wall member via magnetic adhesion, thereby allowing the garment to be displayed in a desired orientation. In this way, the garment may be adequately displayed while maintaining structural integrity and the longevity of the garment.

### CROSS-REFERENCE TO RELATED APPLICATIONS

The present application claims priority to U.S. Provisional Patent Application No. 62/255,047, entitled “MAGNETIC GARMENT HANGERS”, filed on Nov. 13, 2015, the entire contents of which are hereby incorporated by reference for all purposes.

### FIELD

The disclosure relates to a magnetic hanger system and methods for securing garments or other articles for display and storage purposes.

### BACKGROUND/SUMMARY

The present disclosure relates generally to a magnetic garment hanger for use in displaying and storing clothing articles and sports memorabilia garments where the garment may be easily removed and repositioned without damage.

In applications where garments are to be displayed, typical methods for display include hanging the garments on display racks, placing the garments on mannequins, or placing the items into a sealed frame. Conventional methods for garment display present issues such as limited visibility of the entire garment, small space constraints, and potential damage when securing the article on display.

For example, certain types of merchandise in a retail store setting may be marketed to their best advantage by placing such goods in a position so as to be clearly visible to the potential audience. Typically, retail stores display merchandise openly where customers may see and handle the items being displayed, usually on a mannequin, table display, or hanging on a rack. Items having increased demand or value may typically be placed on display in a manner that secures the article while allowing it to be shown prominently. Specifically, garments having a higher value or intrinsic worth are generally displayed in display cases which are sealed and do not allow for quick and easy removal or repositioning.

More specifically, sports memorabilia garments such as scarves and jerseys are widely collected and sought after by sports fans. Often, these jerseys and other forms of memorabilia are valuable and accordingly, it is desirable to display them. Yet, storing and displaying these articles may present potential complications such as causing damage to the garments when placing them in the display or restricting the ability to wear the garments if they are stored behind a sealed case.

Common methods for storing and displaying memorabilia garments have typically required puncturing the article in order to display it on stationary board, using clothing hangers that detract from the aesthetics of the garment on display, or placing the article into a sealed frame which limits the ability of the article to be worn. Previous methods for garment storage and display have also presented space constraints and the present disclosure aims to further alleviate these restrictions while not detracting from the overall visual appeal of the article displayed.

The inventor of the current subject matter has recognized the above issues and has developed an approach to address them. The disclosure herein provides a magnetic hanger assembly for garments that does not require puncturing the garment in any way, and allows for use of the garment when not on display, while still minimizing the amount of space to be used by the display.

An example of the present embodiment provides a method for displaying garments such as shirts or team jerseys without a visible or noticeable hanging apparatus. The invisibility of the hanger assembly allows for a less cluttered display that enhances the visual aesthetic of the garment to be displayed.

In a first embodiment, a hanger assembly may have two parts, a garment casing portion and a wall member. The garment casing of the assembly may have a connecting channel in which receiving grooves are inset for magnets to be placed that correspond to the wall member of the assembly. Although described with the connecting channel in the garment casing, it should be appreciated that the connecting channel may be disposed in the wall member. In further examples, both the wall member and the garment casing may have a corresponding connecting channel. In the illustrated embodiment, here, the wall member of the assembly, for example, may be constructed of a magnetically attractive material that is attracted to the magnets within the garment casing.

The wall member and garment casing of the magnetic hanger assembly may then be held together securely by magnetic attraction forces. The magnets used and described in the subject disclosure are not limited to any particular size or shape as defined by the figures or specification.

It will be appreciated that the magnets used in the disclosed hanger assembly may also vary in strength, allowing for the secure display and storage of bulkier and more robust garments such as hockey jerseys etc. while still allowing for the display of delicate or thin garments with weaker strength magnets so as not to cause undue stress or damage to the article being displayed.

It should be noted that the current descriptions of the disclosed embodiments are not limited to the applications disclosed herein. The applicability of the present subject matter ranges from retail displays to personal garment display and all areas between. For example, the disclosed magnetic hanger assembly may be used in a non-limiting manner for displaying garments in a retail setting, a personal memorabilia display or even a museum or stadium setting where the display must not damage the article, but must keep it secured in place as long as desired.

It should be understood that the brief description above is provided to introduce, in simplified form, a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1A shows a side view of a first embodiment of a magnetic garment hanger assembly mounted onto a mounting surface via a fastener; and an article secured between a wall member and a garment casing.

FIG. 1B is a front view of the first embodiment of the magnetic hanger assembly mounted on the mounting surface showing the article displayed in a vertical and horizontal position, and a garment displayed on the mounting surface.

FIG. 2A shows a rear isometric view of a garment casing of a second embodiment of a magnetic garment hanger.

FIG. 2B shows a front view of the garment casing of the second embodiment of the magnetic garment hanger.

FIG. 2C shows a schematic view of a wall member of the second embodiment of the magnetic garment hanger.

FIG. 3A shows a rear view of a garment casing of an alternative embodiment of the magnetic garment hanger, with a magnet retained in a first position.

FIG. 3B shows the rear view of the garment casing of the alternative embodiment of the magnetic garment hanger, with the magnet retained in a second position.

FIG. 3C shows a front view of the garment casing of the alternative embodiment of the magnetic garment hanger.

FIG. 4A shows a rear view of a garment casing of a third embodiment of a magnetic garment hanger.

FIG. 4B shows a front view of the garment casing of the third embodiment of the magnetic garment hanger.

FIG. 5A shows a rear view of a garment casing of a fourth embodiment of a magnetic garment hanger.

FIG. 5B shows a front view of the garment casing of the fourth embodiment of the magnetic garment hanger.

FIG. 6A shows a rear view of a garment casing of a fifth embodiment of a magnetic garment hanger.

FIG. 6B shows a front view of the garment casing of the fifth embodiment of the magnetic garment hanger.

FIG. 7A shows a rear view of a garment casing of a sixth embodiment of a magnetic garment hanger.

FIG. 7B shows a front view of the garment casing of the sixth embodiment of the magnetic garment hanger.

FIG. 7C shows the front view of the garment casing of the sixth embodiment of the magnetic garment hanger, with a logo mounted on an outer surface of the garment casing.

FIG. 8A shows a rear view of a garment casing of a seventh embodiment of a magnetic garment hanger.

FIG. 8B shows a front view of the garment casing of the seventh embodiment of the magnetic garment hanger.

FIG. 9A shows a rear view of a garment casing of an eighth embodiment of a magnetic garment hanger.

FIG. 9B shows a front view of the garment casing of the eighth embodiment of the magnetic garment hanger.

FIG. 10A shows a rear view of a garment casing of a ninth embodiment of a magnetic garment hanger.

FIG. 10B shows a front view of the garment casing of the ninth embodiment of the magnetic garment hanger.

FIG. 11A shows a rear view of a garment casing of a tenth embodiment of a magnetic garment hanger.

FIG. 11B shows a front view of the garment casing of the tenth embodiment of the magnetic garment hanger.

FIG. 11C shows the front view of the garment casing of the tenth embodiment of the magnetic garment hanger configured with a logo.

FIG. 12 shows a schematic view of the second embodiment of the magnetic garment hanger assembly used to display a first type of garment.

FIG. 13A shows a schematic view of the second embodiment of the magnetic garment hanger assembly used to display a second type of garment.

FIG. 13B shows a schematic view of the tenth embodiment of the magnetic garment hanger assembly used to display the second type of garment.

FIG. 14 shows an example method for displaying a garment using a magnetic garment hanger assembly.

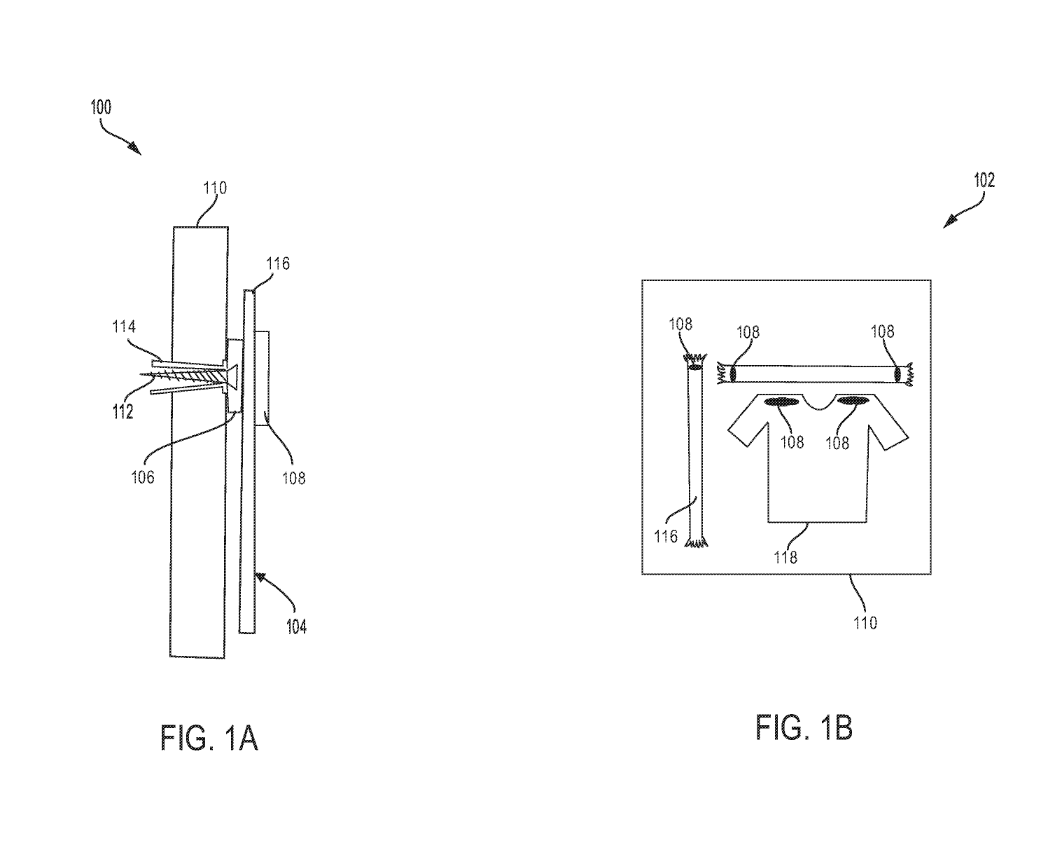

FIGS. 1-13B are drawn to scale, although other relative dimensions may be used, if desired.

### DETAILED DESCRIPTION

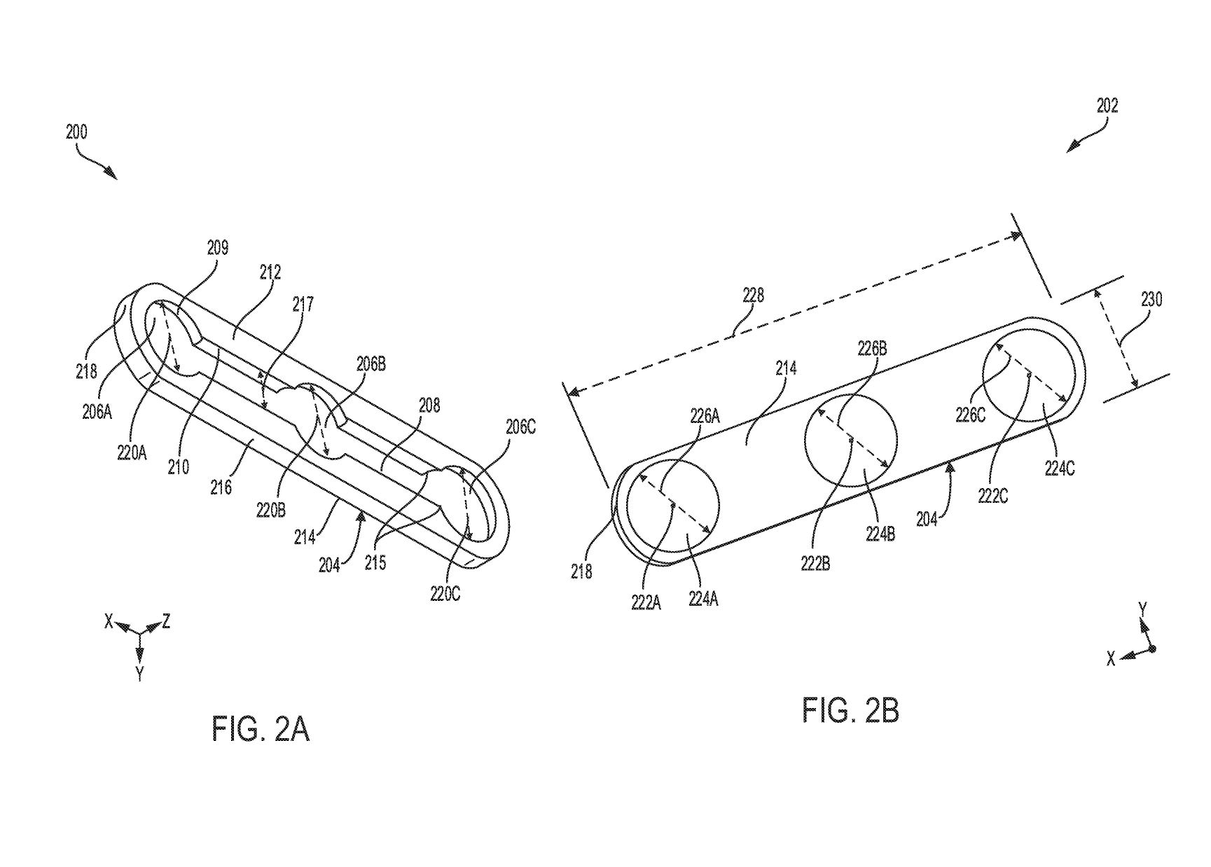

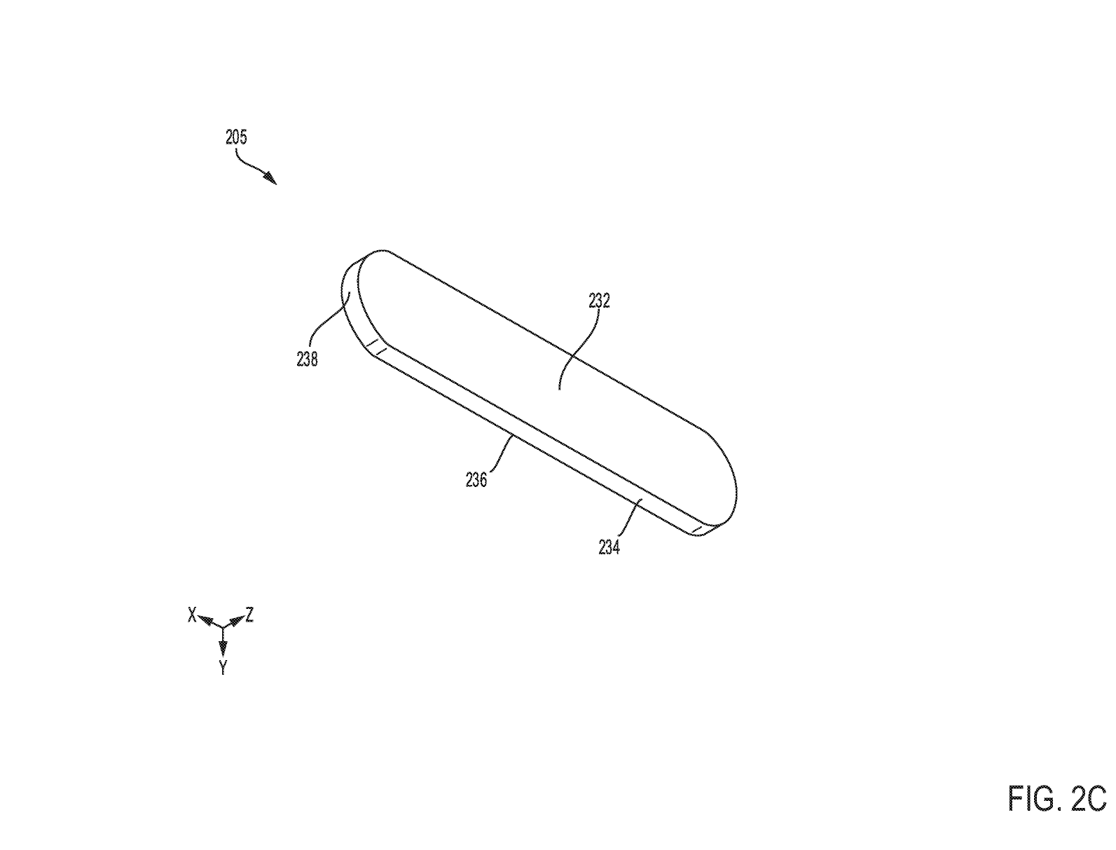

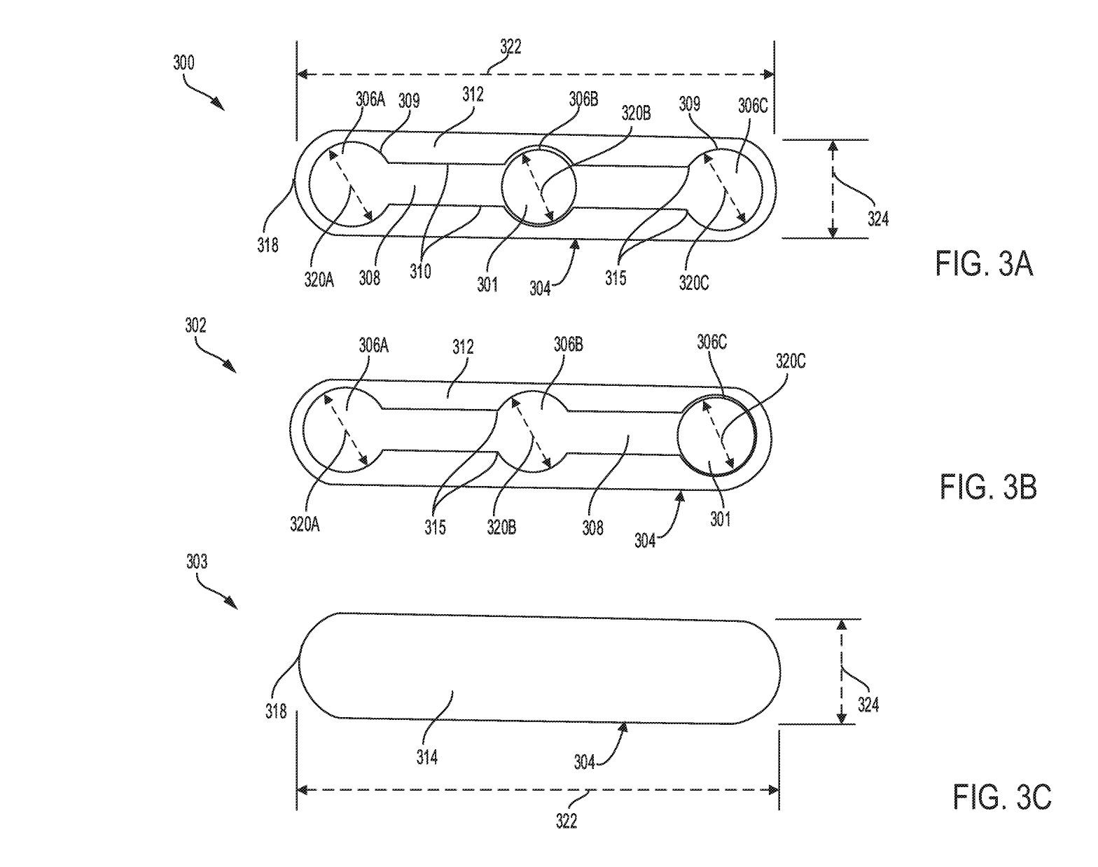

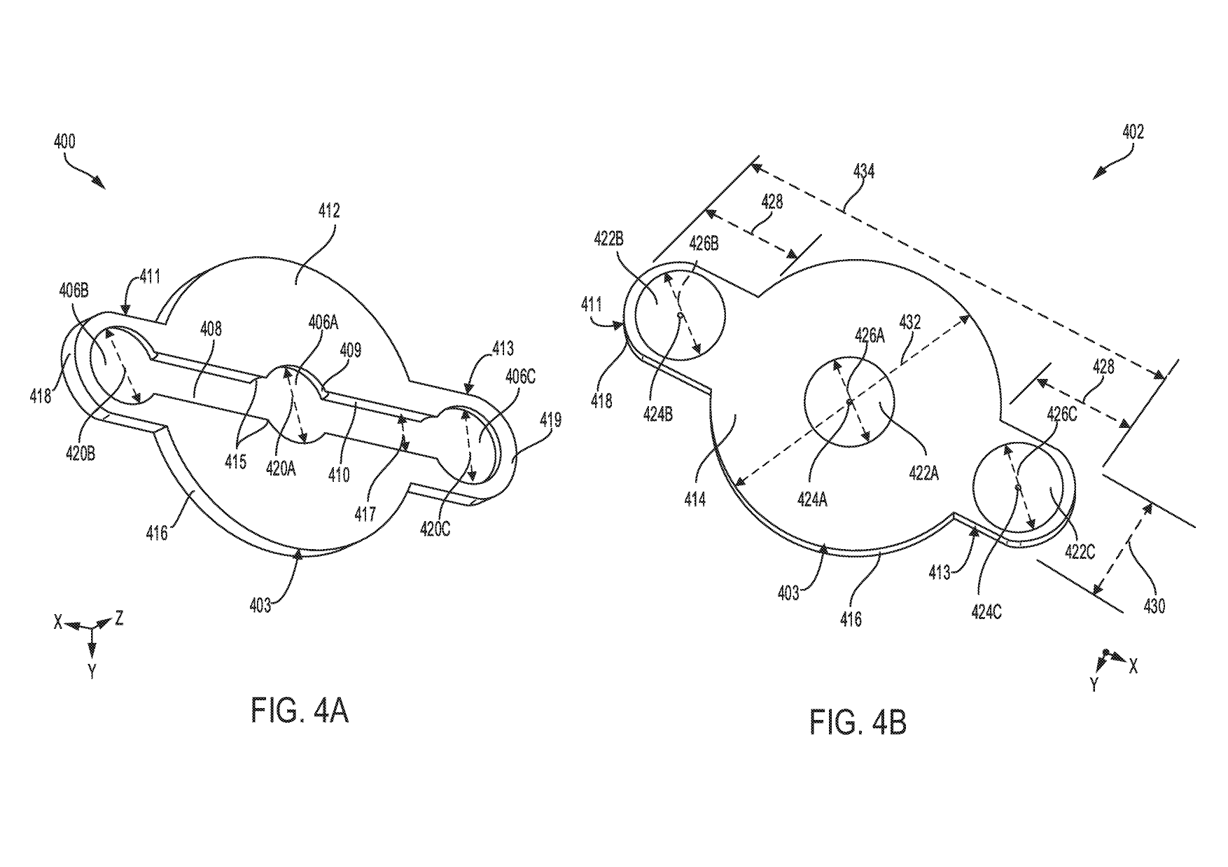

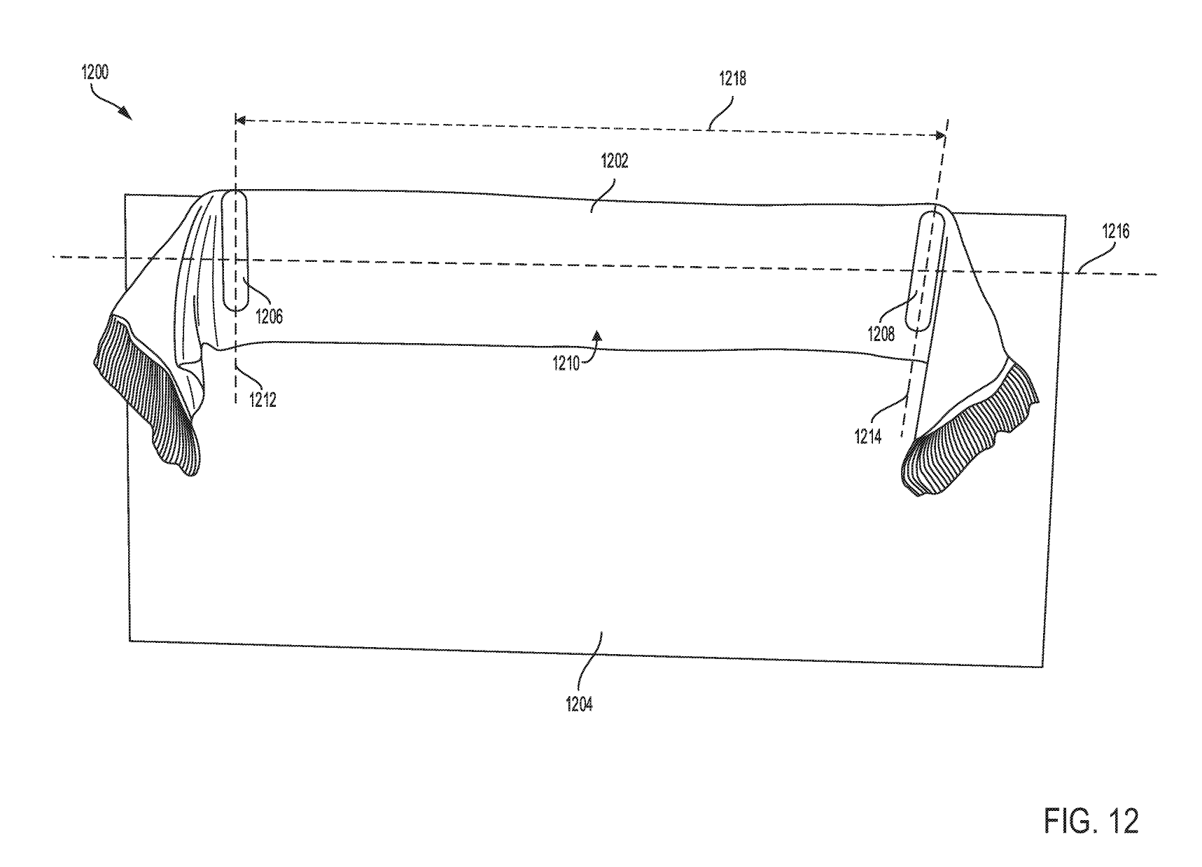

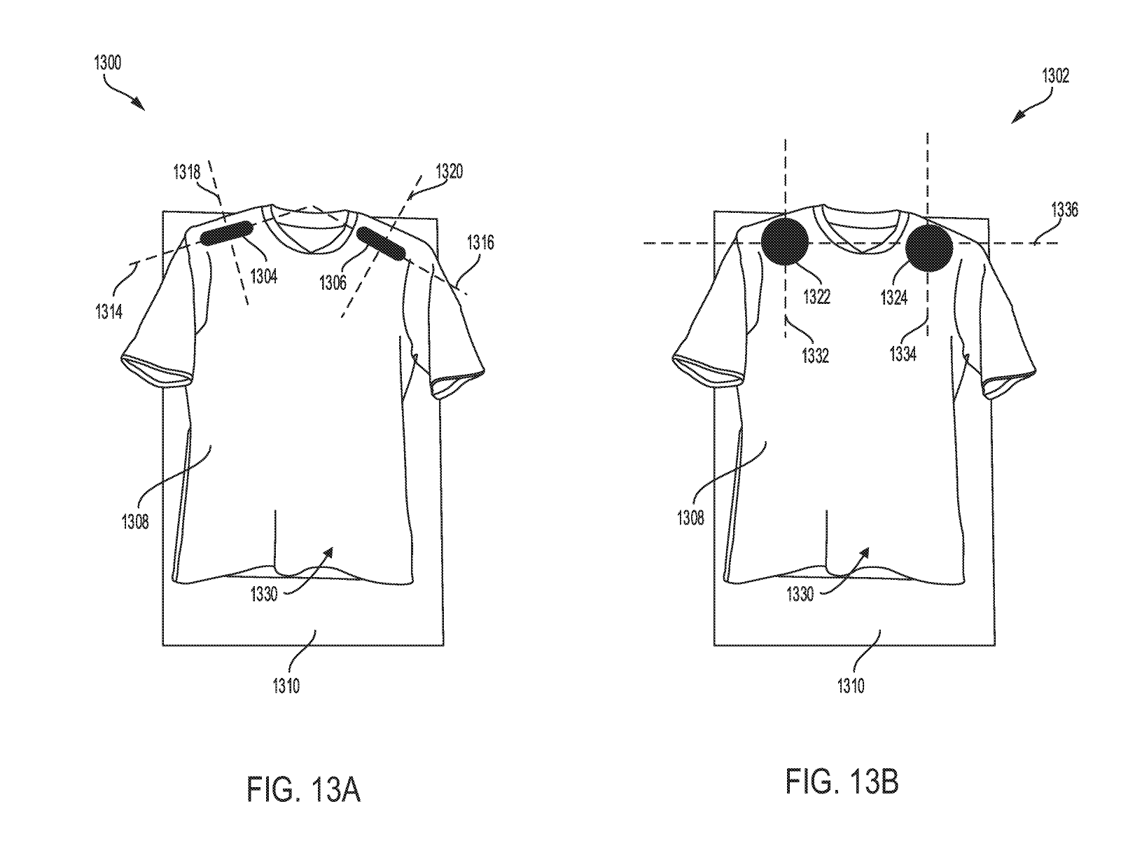

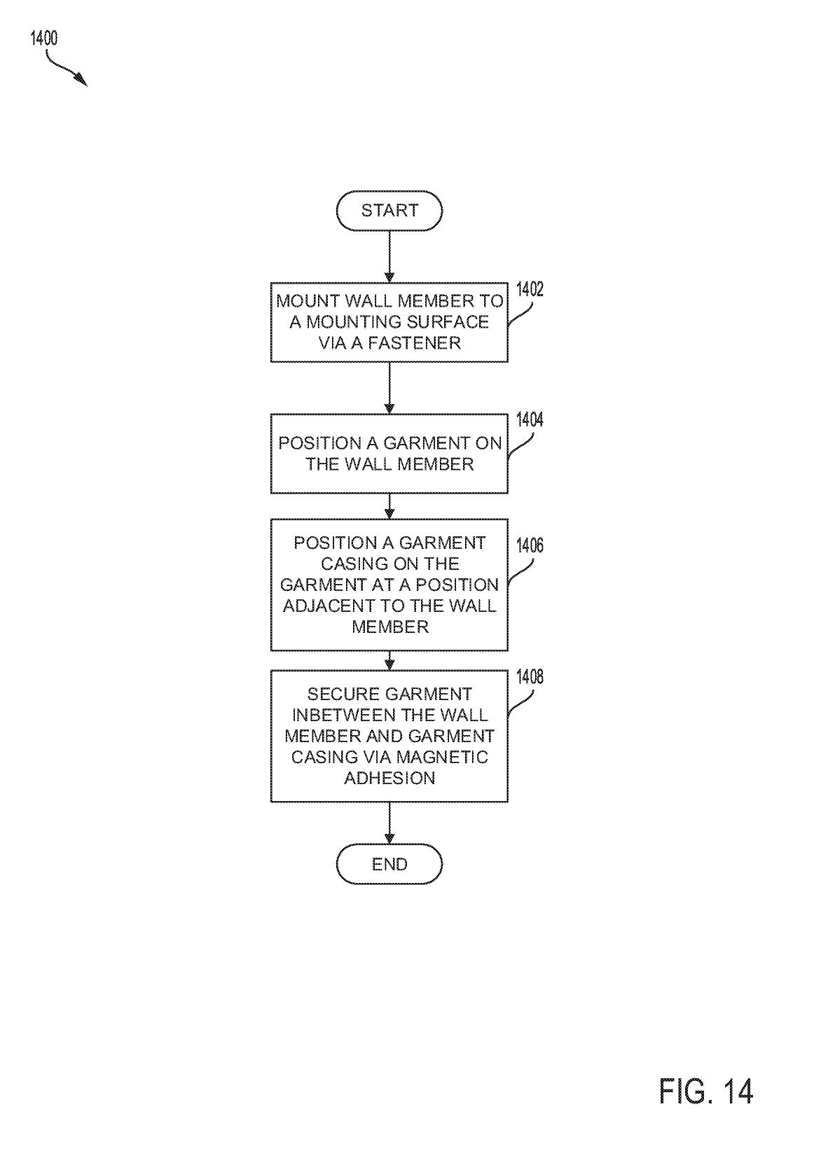

The following detailed description relates to a magnetic hanger assembly system and methods intended for securing garments or other articles for display purposes. The disclosed system and methods do not require puncturing the displayed garment or article, and allows for easy removal and repositioning of the garment or article. The magnetic hanger assembly described herein may be used with garments and articles of various configurations, reasonably supported by magnetic forces exerted by wall and garment casings. FIGS. 1A-B, show a first embodiment of a magnetic hanger assembly for displaying an article or a garment. The hanger assembly comprises a wall member mounted to a wall surface, and a garment casing. The article or garment may be secured between the garment casing and wall member, to securely displaying the article or garment. A garment casing of a second embodiment of a garment hanger assembly comprising a linear plate with a plurality of grooves for retaining one or more magnets is disclosed in FIGS. 2A-B. An alternative embodiment of garment hanger assembly may include a garment casing having dimensions and grooves similar or different from the garment casing of the first embodiment of the garment hanger assembly is shown in FIGS. 3A-C. The grooves in the garment casing may be adequately sized to receive magnets of different sizes and shapes, thereby allowing the garment casing to be used in conjunction with a suitably sized wall member to securely display garments of different sizes and weights while maintaining structural integrity of the garments. Further embodiments of garment hanger assemblies may include garment casings with different shapes and sizes as disclosed in FIGS. 4A-11C, may be used in conjunction with suitable wall members to display garments of various shapes and weights. The garment casings of the further embodiments of the garment hanger assemblies may have grooves of similar sizes and shapes as the grooves of the garment casing in the second embodiment of the garment hanger assembly, for example. In other examples, the garment casings of the further embodiments of the garment hanger assemblies may be configured with grooves of different sizes and shapes. In this way, garment hanger assemblies of different configurations may be used to adequately display garments of different sizes and weights while minimizing damage to the garments. Example garment hanger assembles for securely displaying articles and garments of different shapes are disclosed in FIGS. 12-13B using an example method disclosed in FIG. 14.

FIGS. 1A-13B show example configurations with relative positioning of the various components of a magnetic hanger assembly. Specifically, FIGS. 2A-11C show three dimensional schematics of a garment casing and a wall member of the magnetic hanger assembly. FIGS. 2A-11C include an axis system with a horizontal axis X, a lateral axis Y and a vertical axis Z. Hereafter, ‘length’ may be used to refer to a span of the garment casing or wall member along the horizontal axis X, ‘width’ may be used to refer to a span of the garment casing or wall member along the lateral axis Y, and ‘thickness’ or ‘depth’ or ‘height’ may be used to refer to a span of the garment casing or wall member along the vertical axis Z. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Referring to FIGS. 1A-B, a first view 100 and a second view 102 of a magnetic hanger assembly 104 used to display and store articles or garments is shown. The magnetic hanger assembly 104 comprises a wall member 106 and a garment casing 108. The wall facing member 106 may be secured to a mounting surface 110 using a fastener 112 mounted inside a plug 114 extended through the mounting surface 110. The wall member 106, may be comprised of magnetic materials that form a magnetic surface for attachment.

As shown in FIG. 1A, the article 116 may be securely held in between the wall member 106 and garment casing 108 of the magnetic hanger assembly 104 by magnetic adhesion between the wall member 106 and garment casing 108. As an example, the garment casing 108 may include a plurality of grooves to retain one or more magnets which may attach to the wall member 106, when the garment casing 108 is positioned adjacent to the wall member. The wall member 106 and garment casing 108 of the magnetic hanger assembly may be held together securely by magnetic attraction forces. In this case, the article 116 may be secured in between the wall member 106 and garment casing 108 via magnetic adhesion, thereby allowing the article 116 to be adequately displayed on the mounting surface 110. As an example, the mounting surface 110 may include a fixed surface such as a wall. In another example, the mounting surface 110 may be a movable vertical display surface, which may be moved from a first position to a second position. In one example, the movable vertical display surface may be comprised of magnetic materials, thereby allowing the wall member 106 to be directly mounted to the display surface with or without a fastener. Details on grooves formed on the garment casing 108 to retain at least one magnet, is disclosed further with reference to FIGS. 2A-11C.

When displayed on the mounting surface 110, the article 116 and garment 118 may rest between the wall member 106 (not shown) and the garment casing 108 of the magnetic hanger assembly, as shown in FIG. 1B. As an example, the article 116 may be displayed vertically on the mounting surface 110 using the wall member 106 and garment casing 108. In another example, the article 116 may be displayed horizontally on the mounting surface 110 using two or more wall and garment casings. In another example, the garment 118 may be displayed on the mounting surface 110 using two or more wall members and garment casings. In other examples, where the mounting surface 110 may be comprised of magnetic materials, the wall member 106 may be directly attached to the mounting surface 110 via a magnetic attractive force exerted by one or more magnets retained in the grooves of the garment casing 108; the attractive force securing the article 116 or garment 118 between the wall member 106 and garment casing 108. In alternative examples, the article 116 or garment 118 may be securely displayed on the mounting surface 110 via magnetic adhesion between the garment casing 108 and a magnetic surface of the mounting surface 110. In this way, the garment hanger assembly 104 may be used to securely display articles and garments on the mounting surface 110 via magnetic adhesion between the wall member 106 and garment casing 108. Although shown as a linear shape, the garment casing 108 of the magnetic hanger assembly 104, may have various shapes, as disclosed further below with reference to FIGS. 2A-11C.

Referring to FIGS. 2A-B, a first view 200 and a second view 202, respectively of a garment casing 204 of a second embodiment of a magnetic hanger assembly (such as garment hanger assembly 104 shown in FIG. 1A) is shown. The magnetic hanger assembly may be used to display an article or a garment, such as article 116 or garment 118 shown in FIG. 1B. The garment casing 204 may include a plurality of grooves 206A-C and connecting channels 208, surrounded by a raised outer surface 212. As an example, the grooves 206A-C and raised outer surface 212 may form a first side of the garment casing 204. A second side, opposite to the first side of the garment casing 204, may comprise a flat surface 214 having a plurality of circular markings 224A-C. The circular markings 226A-C may have slots 222A-C, respectively formed in a central section of each circular marking. The garment casing 204 may further include a sidewall 216 and curved outer ends 218.

As shown in FIG. 2A, the grooves 206A-C formed on the first side of the garment casing 204 may have diameters 220A-C, respectively each groove 206A-C adequately sized to receive a magnet. As an example, each diameter 220A-C of each groove 206A-C may be at least 0.50 inches. Each groove 206A-C may have a lip surface 209 configured to securely retain the magnet inside any of the grooves 206A-C. In one example, the lip surface 209 may have a width of at least 0.03 inches. When the magnet is disposed in any of the grooves 206A-C, the lip surface 209 formed by interior walls surrounding each groove 206A-C, may be in face-sharing contact with a circumferential surface of the magnet, thereby securely retaining the magnet in any of the grooves 206A-C. Any adjacent pair of grooves 206A-C may be connected by the connecting channel 208 having internal sidewalls 210. As an example, the internal sidewall 210 of the connecting channel 208 may connect to each groove 206A-C at curved junctions 215. In another example, connecting channel may have a width 217, adequately sized to receive a tool for propping out a magnet retained inside any groove 206A-C. In one example, the width 217 of the connecting channel 208 may be smaller than each diameter 220A-C of each groove 206A-C, and may be at least 0.3437 inches. Also, the connecting channel 308 may have a length of at least 5.0 inches and a depth of at least 0.3125 inches.

The multiple circular markings 226A-C on the flat surface 214 of the garment casing 204 shown in FIG. 2B, may to receive one or more logos. As an example, the circular markings 224A-C may have diameters 226A-C, respectively sized to fit one or more logos that may be mounted to the flat surface 214 of the garment casing 204. The garment casing 204 may have a length 228. As an example, the length 228 of the garment casing 204 may be at least 5.875 inches. Also, the garment casing 204 may have a width 230 larger than the circular markings 224A-C. As an example, the width 230 of the garment casing 204 may be at least 1.25 inches. In further examples, the garment casing 204 may have a height of at least 0.375 inches. In this way, the garment casing 204 may be adequately sized to securely display the garment while minimizing undue stresses and damage to the garment. The outer edges 218 of the garment casing 204 may be rounded, for example. In alternative embodiments of the garment casing 204, the outer edges 218 may have other shapes.

Now turning to FIG. 2C, a schematic view of a wall member 205 of the magnetic hanger assembly is shown. The wall member 205 may be used in conjunction with the garment casing 204 disclosed in FIGS. 2A-B, forming the magnetic hanger assembly for displaying garments on a mounting surface. The wall member 205 may have a similar shape and dimensions as the garment casing 204, for example. In other examples, the wall member 205 may have a different shape and dimensions compared to the garment casing 204. As shown in FIG. 2C, the wall member 205 may include an outer face 232, a side face 234, an inner face 236 and outer edges 238.

The outer face 232 may be a flat surface composed of a magnetic material, for example. Although not shown, the outer face 232 may include a plurality of grooves and a connecting channel; the grooves adequately sized to receive at least one magnet. In one example, the grooves in the wall member 205 may be similar to grooves 206A-C in FIG. 2A, each groove configured to retain at least one magnet. In other examples, the outer face 232 may have one or more slots to receive a fastener for securing the wall member 205 to the mounting surface. The inner face 236 may be a flat surface that is in face-sharing contact with the mounting surface when attached to the mounting surface. The inner face 236 of the wall member 205 may have a magnetic surface, thereby allowing the wall member to directly attach to a magnetic mounting surface, for example. The outer edges 238 of the wall member 205 may be curved or rounded edges, for example. In alternative embodiments, the outer edges 238 of the wall member 205 may have other shapes. Although shown to have a similar shape and size as the garment casing 204, wall member 205 may have a different shape and/or size from the garment casing 204.

Turning back to FIGS. 2A-B, when positioned adjacent to the wall member 205 attached to the mounting surface, the first side of the garment casing 204 may be in facing-sharing contact with a first portion of the garment while the outer surface 232 of the wall member 205 may be in face-sharing contact with a second portion of the garment. The garment casing 204 and wall member 205 of the magnetic hanger assembly may be held together securely by magnetic attraction forces. The garment may be secured in between the garment casing 204 and wall member 205 via magnetic adhesion between the garment casing 204 and wall member 205. The magnetic adhesion may be due to a magnetic attraction force exerted by the magnets in the garment casing 204, thereby allowing the garment to be secured in between the garment casing and wall member. As an example, the garment casing 204 may be oriented vertically or horizontally when used to secure the garment to the wall member 205 mounted on the mounting surface. In another example, the garment displayed may include items such as shirts, dresses, scarves etc. The garment may be displayed with the garment hanger assembly not visible. The invisibility of the garment hanger assembly allows for a less cluttered display that enhances the visual aesthetic of the garment to be displayed.

In this way, the garment may be securely retained between the garment casing 204 and wall member 205, in a suitable display position that minimizing stress exerted on the garment. The garment casing 204 and wall member 205 form the garment hanger assembly that allows the garment to be adequately displayed in unobstructed position while minimizing damage on the garment.

Referring to FIGS. 3A-C, a first view 300, a second view 302 and a third view 303, respectively of an alternative embodiment of a garment casing 304 of a magnetic hanger assembly (such as hanger assembly 104 shown in FIG. 1A) is shown. The garment casing 304 includes a first groove 306A, a second groove 306B, a third groove 306C, and connecting channels 308, surrounded by a raised outer surface 312. The grooves 306A-C and raised outer surface 316 form a first side of the garment casing 304. A second side of the garment casing 304, comprises a flat surface 314 that may be used to display one or more logos. The garment casing 304 may further include curved outer ends 318, with rounded ends.

As shown in FIGS. 3A-B, each of the first, second and third grooves 306A-C of the garment casing 304 may be connected by a connecting channel 308 having sidewalls 310. As an example, the sidewalls 310 of the connecting channel 308 may connect to each groove 306A-C at curved junctions 315. The grooves 306A-C may have diameters 320A-C, respectively, each diameter 320A-C adequately sized to receive a magnet 305. As an example, each diameter 320A-C of each groove 306A-C may be at least 0.5 inches. Each groove 306A-C may have a lip surface 309 configured to securely retain the magnet 305 inside each groove 306A-C. The lip surface 309 may have a width of at least 0.03 inches. When the magnet 305 is retained in any of the grooves 306B-C, the lip surface 309 formed by interior walls surrounding each groove 306B-C, may be in face-sharing contact with an outer perimeter of the magnet 305, thereby securely retaining the magnet 305 inside the grooves 306B-C. As an example, the magnet 305 may be disposed inside the second groove 306B, and retained inside the groove 306B by the lip surface 309 as shown in FIG. 3A. In this case, the garment casing 304 may be positioned adjacent to a wall member (e.g., wall member 205 shown in FIG. 2C), forming a magnetic hanger assembly for displaying the garment vertically or horizontally, as shown in FIG. 1B. The garment casing 304 and wall member of the magnetic hanger assembly may be held together securely by magnetic attraction forces. The garment may be secured in between the garment casing 304 and wall member via magnetic adhesion between the garment casing 304 and wall member. In an alternative example, the magnet 305 may be retained inside the first groove 306A or third groove 306C, to display the garment horizontally. In other examples, each groove 306A-C of the garment casing 304 may contain a magnet with an adequate magnetic strength to secure one or more garments for display. In one example, the magnetic strength of the magnet 305 retained in each groove 306B-C of the garment casing 304 may be selected to have a wide range, thereby allowing garments of various weights to be securely displayed. In this way, the garment casing 304 may be in conjunction with the wall member to form the garment hanger assembly for securely displaying garments of various weights. The connecting channel 308 connecting to each groove 306A-C, may have a width 317, adequately sized to receive a tool for propping out the magnet 305 retained in any groove 306B-C. As an example, the width 317 of the connecting channel 308 may be smaller than each diameter 320A-C of each groove 306A-C. In one example, the width 317 may be at least 0.3437 inches. Further, the connecting channel 308 may have a length of 5.0 inches and a depth of 0.3125 inches.

The flat surface 314 on the second side of the garment casing 304 may include markings (e.g., circular markings 224A-C shown in FIG. 2B) to receive one or more logos, which may be mounted to the garment casing. The garment casing 304 may have a length 322 of at least 5.875 inches. Further, the garment casing 304 may have a width 324 larger than each diameter 320A-C of each groove 306A-C. As an example, the width 324 of the garment casing 304 may be at least 1.25 inches. Also, the garment casing 304 may have a height of at least 0.375 inches. In this way, various sizes of garment casings may be used in conjunction with the wall member to adequately display garments of various sizes and weights while minimizing stress exerted on the garments.

Referring to FIGS. 4A-B, a first view 400 and a second view 402, respectively of a garment casing of a third embodiment of a magnetic hanger assembly is shown. The magnetic hanger assembly may be used to display an article or a garment (e.g., article 116 or garment 118 shown in FIG. 1B). The garment casing includes a circular portion 403 with a first extended arm 411 and a second extended arm 413. The circular portion 403 includes a groove 406A and connecting channels 408, surrounded by a raised outer surface 412. The circular portion 403 may further include side walls 416, forming an outer boundary of the circular portion. The first and second extended arms 411 and 413 include grooves 406B-C, respectively. Each groove 406B-C is connected to the connecting channel 408, and surrounded by a planar surface 419. The grooves 406A-C, connecting channels 408, raised outer surface 412 and planar surface 419 form a first side of the garment casing. A second side of the garment casing, comprises a flat surface 414 with markings 424 that may be used to display one or more logos. Each of the first and second extended arm may include a curved outer edge 418 that defines an outer boundary of each extended arm.

As shown in FIG. 4A, the grooves 406A-C formed on the garment casing may have diameters 420A-C, respectively, each groove 406A-C adequately sized to receive a magnet (e.g., magnet 305 shown in FIGS. 3A-B). As an example, each diameter 420A-C of each groove 406A-C may be at least 0.5 inches. Although shown to have a similar shape and diameter, each groove 406A-C of the garment casing may have a different shape and/or diameter, thereby allowing magnets of different shapes and/or sizes to be mounted in any of the grooves 406A-C. Each groove 406A-C of the garment casing may have a lip surface 409 configured to securely retain the magnet inside each groove 406A-C. As an example, the lip surface 409 may have a width of at least 0.03 inches. When the magnet is retained in any of the grooves 406A-C, the lip surface 409 formed by interior walls surrounding each groove 406A-C, may be in face-sharing contact with a circumferential surface of the magnet, thereby retaining the magnet in any of the grooves 406A-C. Each adjacent pair of grooves 406A-C is connected to sidewalls 410 of the connecting channel 408. As an example, the sidewalls 410 of the connecting channel 408 may connect to each groove 406A-C at curved junctions 415. In another example, connecting channel 408 may have a width 417, adequately sized to receive a tool for removing magnets mounted inside any of the grooves 406A-C. In one example, the width 417 of the connecting channel 408 may be smaller than each diameter 420A-C of each groove 406A-C, and may be at least 0.3437 inches. Also, the connecting channel 408 may have a length of 5.0 inches and a depth of 0.3125 inches.

The flat surface 414 of the garment casing includes a plurality of circular markings 422A-C to receive one or more logos which may be mounted to the flat surface 414. The circular markings 422A-C may have slots 424A-C, respectively formed at a central section of each circular marking 422A-C. As an example, the circular markings 422A-C may be formed on the second side of the garment casing including the circular portion 403, first extended arm 411 and the second extended arm 413. In one example, the circular marking 422A-C may have diameters 426A-C, respectively sized to fit the logo that may be mounted to the garment casing.

The outer edge 418 of each first and second extended arm of the garment casing may be rounded, for example. In alternative embodiments of the garment casing, the outer edge 418 of each extended arm 411 and 413 may be formed using other shapes. Each first and second extended arm of the garment casing may have a length 428 and a width 430. As an example each length 428 and width 430 of the extended arms may be larger than each diameter 420A-C of each groove 406A-C. The circular portion 403 may have a diameter 432, larger than each diameter 426A-C of each circular marking 426A-C on the garment casing. As an example, the diameter 432 of the circular portion 403 may be at least 3.5 inches. The garment casing may have a length 434, larger than the diameter 432 of the circular portion 403. For example, the length 434 of the garment casing may be at least 5.875 inches. In this way, various sizes of the garment casing may be used in conjunction with a wall member (e.g., wall member 106 shown in FIG. 1A) to adequately display garments of various shapes and weights while minimizing stresses exerted on the garments.

When positioned adjacent to the wall member attached to a mounting surface, the first side of the garment casing may be in facing-sharing contact with a first portion of the garment while the wall member makes face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. As an example, the garment casing may be oriented vertically or horizontally when used to secure the garment to the wall member mounted on the mounting surface. Although a wall member having a similar shape and size as the garment casing may form the magnetic garment assembly used to display the garment, other shapes and sizes of wall members different from the garment casing may be utilized. In this way, the garment casing and wall member form the garment hanger assembly used to adequately display garments of various shapes and weights while minimizing undue stress or damage on the garment.

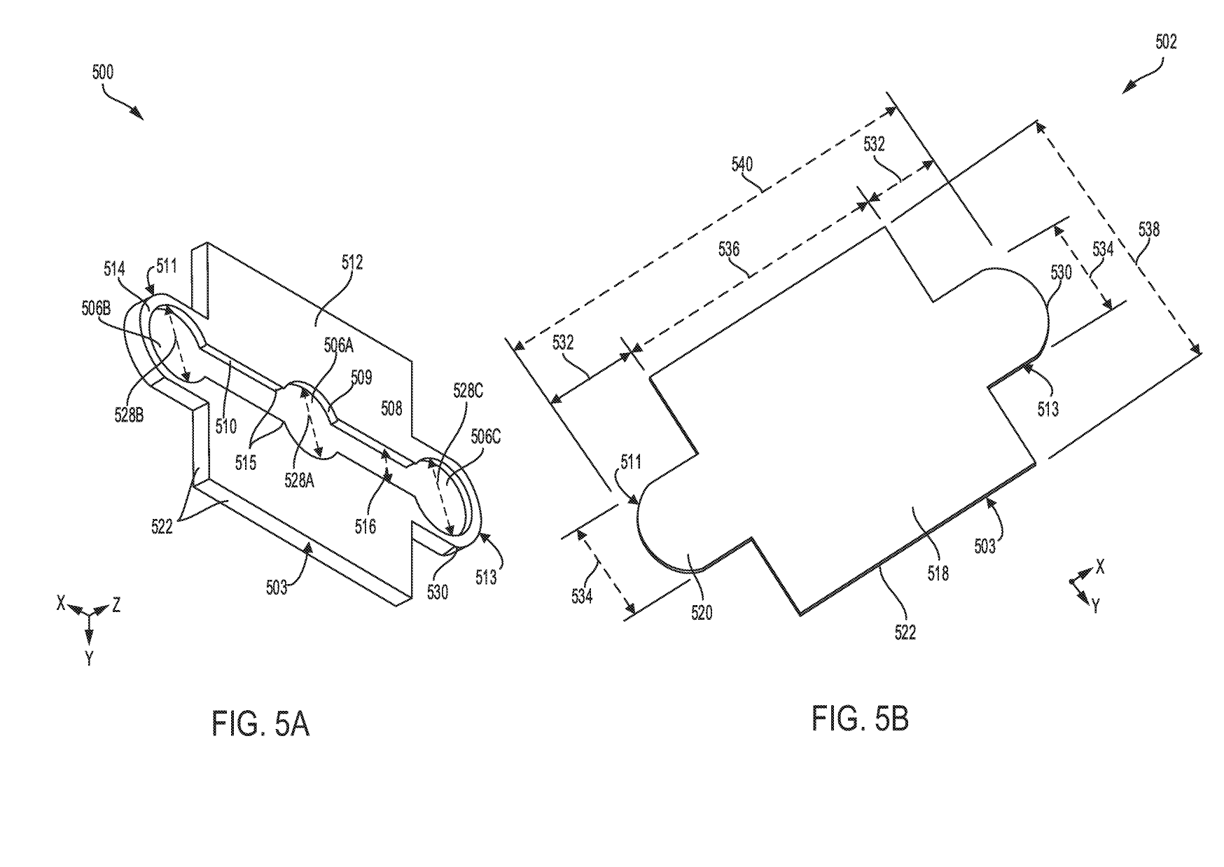

Referring to FIGS. 5A-B, a first view 500 and a second view 502, respectively of a garment casing of a fourth embodiment of a magnetic hanger assembly (such as hanger assembly 104 shown in FIG. 1B) is shown. The magnetic hanger assembly may be used to display an article or a garment (e.g., article 116 or garment 118 shown in FIGS. 1A-B). The garment casing includes a square portion 503 having a first extended portion 511 and a second extended portion 513. The square portion 503 includes a groove 506A and connecting channels 508, surrounded by a raised outer surface 512. Each of the first and second extended portions 511 and 513 may include grooves 506B-C, respectively connected to the connecting channel 508, and surrounded by a raised planar portion 514. The grooves 506A-C, connecting channel 508, raised outer surface 512 and planar portion 514 may form a first side of the garment casing. A second side of the garment casing, may comprise a flat surface 518 and planar surfaces 520, which may be used to display one or more logos. The square portion 503 of the garment casing may further include side walls 522 forming an outer boundary of the square portion. Similarly, each of the first and second extended portions include a curved outer edge 524 that defines an outer boundary of each extended portion, and joins the square portion at junctions 526.

As shown in FIG. 5A, the grooves 506A-C formed on the garment casing may have diameters 528A-C, respectively, each groove 506A-C adequately sized to receive a magnet (e.g., magnet 305 shown in FIGS. 3A-B). As an example, each diameter 528A-C of each groove 506A-C may be at least 0.5 inches. Although shown to have a similar shape and diameter, each groove 506A-C of the garment casing may have different shapes and diameters. In this way, magnets of different shapes and sizes may be retained in any of the grooves 506A-C of the garment casing. Each groove 506A-C may have a lip surface 509 configured to securely retain the magnet inside each groove 506A-C. As an example, the lip surface 509 may have a width of at least 0.03 inches. When the magnet is retained in any of the grooves 506A-C, the lip surface 509 formed by interior walls surrounding each groove 506A-C, may be in face-sharing contact with a circumferential surface of the magnet, thereby retaining the magnet in any of the grooves 506A-C. Each adjacent pair of grooves 506A-C is connected to sidewalls 510 of the connecting channel 508. As an example, the sidewalls 510 of the connecting channel 508 may connect to each groove 506A-C at curved junctions 515. In another example, connecting channel 508 may have a width 516, adequately sized to receive a tool for removing magnets mounted inside one or more grooves 506A-C. In one example, the width 516 of the connecting channel 508 may be at least 0.3437 inches. Also, the connecting channel may have a length of 5.0 inches and a depth of 0.3125 inches.

The flat surface 518 and planar surface 520 of the garment casing may include a plurality of markings to receive one or more logos. The outer edges 530 of each first and second extended portions 511 and 513 of the garment casing may be rounded, for example. In alternative embodiments, the outer edges 530 of the garment casing may have other shapes. Each first and second extended portions 511 and 513 may have a length 532 and a width 534. As an example the length 532 and width 534 may be larger than each diameter 528A-C of the each groove 506A-C. The square portion 503 may have a length 536 and a width 538, larger than the length 532 of each extended portion 511 and 513. As an example, the length 536 of the square portion 503 may be at least 3.5 inches and the width 538 may be at least 3.5 inches. The garment casing may have a length 540, larger than the length 536 of the square portion 503. As an example, the length 540 of the garment casing may be at least 5.875 inches. In this way, various sizes of the garment casing may be used in conjunction with a wall member (e.g., wall member 106 shown in FIG. 1A) mounted to a mounting surface, forming a magnetic garment hanger assembly used to securely display garments of different shapes and weights.

When positioned adjacent to the wall member, the first side of the garment casing may be in facing-sharing contact with a first portion of the garment while the wall member makes face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. For example, the garment casing may be oriented vertically or horizontally when used to secure the garment to the wall member mounted on the mounting surface. Although the wall member with a similar shape and size as the garment casing may be used to display the garment, other shapes and sizes of wall members different from the garment casing may be utilized. In this way, the garment casing and wall member may form the magnetic garment hanger assembly that adequately displays the garment while minimizing stress and damage on the garment.

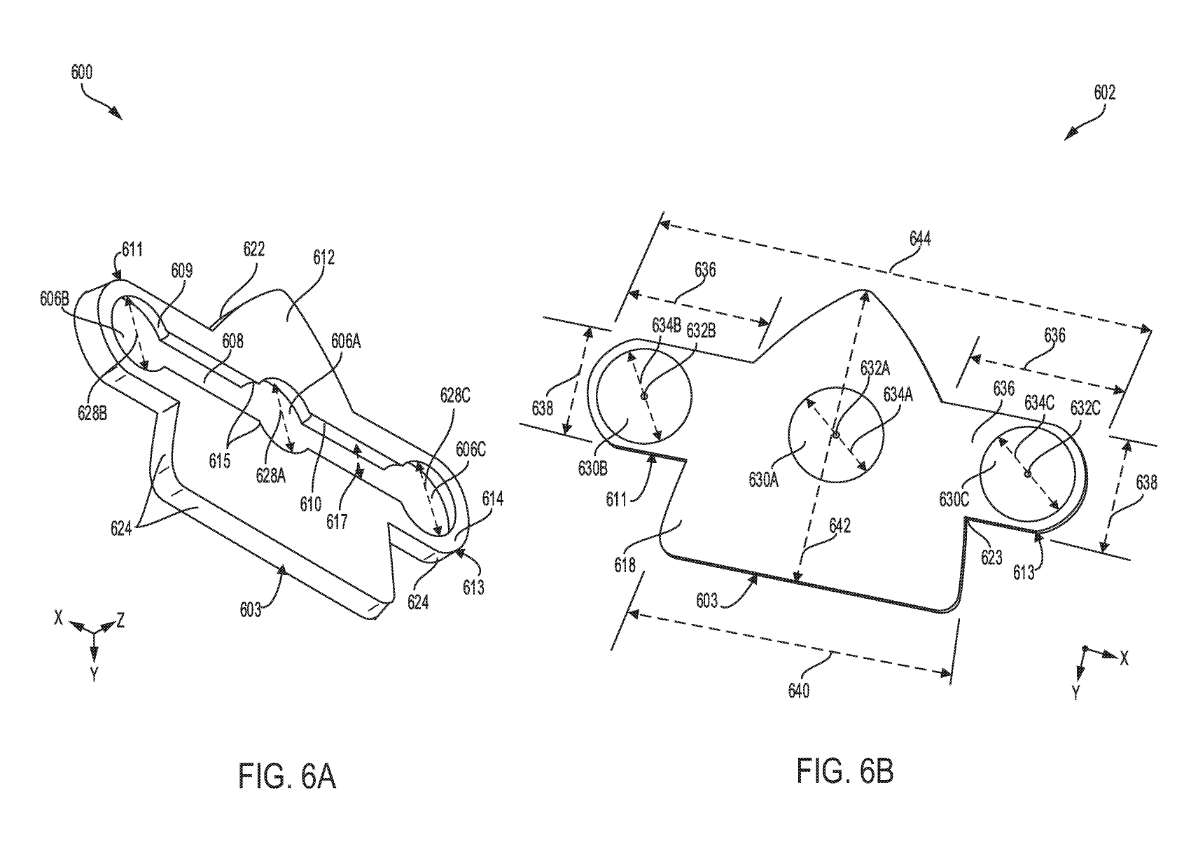

Referring to FIGS. 6A-B, a first view 600 and a second view 602, respectively of a garment casing (e.g., garment casing 108 shown in FIGS. 1A-B) of a fifth embodiment of a magnetic hanger assembly is shown. The magnetic hanger assembly may be used to display an article or a garment (e.g., article 116 or garment 118 shown in FIGS. 1A-B). The garment casing includes a triangular portion 603 with a first extended portion 611 and a second extended portion 613. The triangular portion 603 includes a groove 606A and connecting channels 608, surrounded by a raised outer surface 612. The first and second extended portions of the garment casing include grooves 606B-C, respectively. Each groove 606B-C may be connected to the connecting channel 608, and surrounded by a raised planar portion 614. The grooves 606A-C, connecting channel 608, raised outer surface 612 and planar portion 614 form a first side of the garment casing. A second side of the garment casing, comprises a flat surface 618 and planar surface 620, which may be used to display one or more logos. The triangular portion 603 further includes side walls 622 forming an outer boundary of the triangular portion. Similarly, each of the first and second extended portions include a curved outer edge 624 that defines an outer boundary of each extended portion, and joins the triangular portion at junctions 626.

As shown in FIG. 6A, the grooves 606A-C formed on the garment casing may have diameters 628A-C, respectively, each groove 606A-C adequately sized to receive a magnet (e.g., the magnet 305 shown in FIGS. 3A-B). As an example, each diameter 628A-C of each groove 606A-C may be at least 0.5 inches. Although shown to have a similar shape and diameter, each groove 606A-C of the garment casing may have different shapes and diameters. In this way, magnets of different shapes and sizes may be retained in any of the grooves 606A-C of the garment casing. Each groove 606A-C may have a lip surface 609 configured to securely retain the magnet inside each groove 606A-C of the garment casing. When the magnet is retained in any of the grooves 606A-C, the lip surface 609 formed by interior walls surrounding each groove 606A-C, may be in face-sharing contact with a circumferential surface of the magnet, thereby retaining the magnet inside any of the grooves 606A-C. Each adjacent pair of grooves 606A-C may be connected by sidewalls 610 of the connecting channel 608. As an example, the sidewalls 610 of connecting channel 608 may connect to each groove 606A-C at curved junctions 615. In another example, connecting channel 608 may have a width 617, adequately sized to receive a tool for removing magnets mounted inside any of the grooves 606A-C. In one example, the width 617 of the connecting channel 608 may be at least 0.3437 inches. Also, the connecting channel may have a length of 5.0 inches and a depth of 0.3125 inches.

The flat surface 618 and planar surface 620 on the second side of the garment casing may include a plurality of circular markings 630A-C to receive one or more logos. The circular markings 630A-C may include slots 632A-C formed in a central section of each circular marking. As an example, the circular markings 630A-C may have diameters 634A-C, respectively sized to fit one or more logos that may be mounted to the garment casing.

The outer edges 624 of each first and second extended portions of the garment casing may be rounded, for example. In alternative embodiments of the garment casing, the outer edges 624 may have other shapes. Each first and second extended portion 611 and 613 of the garment casing may have a length 636 and a width 638. The triangular portion 603 may have a length 640 and a width 642, larger than the length 636 of each extended portion 611 and 613. As an example, the length 640 of the triangular portion 603 may be at least 3.0 inches and the width 642 may be at least 3.5 inches. The garment casing may have a length 644, larger than the length 640 of the triangular portion 603. As an example, the length 644 of the garment casing may be at least 5.875 inches. Further, the garment casing may have a thickness of at least 0.375 inches. In this way, various sizes of the garment casing may be used in conjunction with a wall member (e.g., wall member 106 shown in FIG. 1A) mounted to a mounting surface, forming a magnetic garment hanger assembly which adequately displays garments of different sizes and weights while minimizing stress exerted on the garments.

When positioned adjacent to the wall member, the first side of the garment casing may be in facing-sharing contact with a first portion of the garment while the wall member makes face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. For example, the garment casing may be oriented vertically or horizontally when used to secure the garment to the wall member mounted on the mounting surface. Although the wall member with a similar shape and size as the garment casing may be used to display the garment, other shapes and sizes of wall members different from the garment casing may be utilized. In this way, the garment casing and wall member may form the magnetic hanger assembly used to adequately display the garment while minimizing stress and damage to the garment.

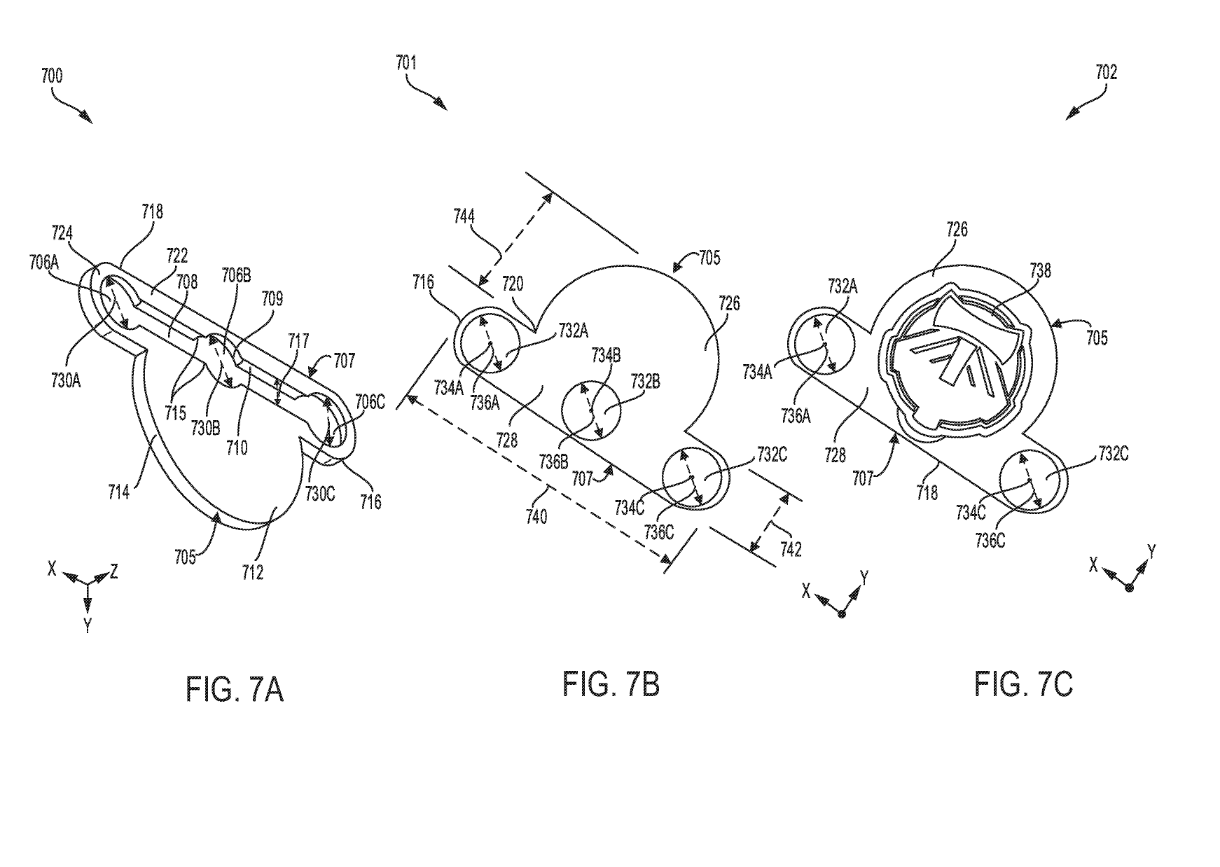

Referring to FIGS. 7A-C, a first view 700, a second view 701 and a third view 702, respectively of a garment casing of a sixth embodiment of a magnetic hanger assembly is shown. The magnetic hanger assembly may be used to display an article or a garment (e.g., article 116 or garment 118 shown in FIG. 1B). The garment casing includes a semi-circular portion 705 and a linear portion 707. The semi-circular portion 705 includes a raised outer surface 712 and a sidewall 714. The sidewall 714 of the semi-circular portion 705 forms an outer boundary of the semi-circular portion. Similarly, the linear portion 707 includes curved outer edges 716 and a side portion 718 that defines an outer boundary of the linear portion 707, and joins the semi-circular portion at junctions 720. The linear portion 707 includes a plurality of grooves 706A-C and connecting channels 708, surrounded by the raised outer surface 712 and planar surfaces 722 and 724 on a first side of the garment casing. A second side of the garment casing comprises a flat surface 726 and planar surface 728, which may be used to display one or more logos.

As shown in FIG. 7A, the grooves 706A-C formed on the first side of the garment casing may have diameters 730A-C, respectively. Each groove 706A-C may be adequately sized to receive a magnet (e.g., magnet 305 shown in FIGS. 3A-B). As an example, each diameter 730A-C of each groove 706A-C may be at least 0.5 inches. Although shown to have a similar diameter and shape, each groove 706A-C of the garment casing may have a different diameter and shape. In this way, magnets of different sizes and shapes may be retained in any of the grooves 706A-C of the garment casing. Each groove 706A-C may have a lip surface 709 configured to securely retain the magnet inside each groove 706A-C. When the magnet is disposed inside any of the grooves 706A-C of the garment casing, the lip surface 709 formed by interior walls surrounding each groove 706A-C, may be in face-sharing contact with a circumferential surface of the magnet, thereby retaining the magnet inside any of the grooves 706A-C. Each adjacent pair of grooves 706A-C may be connected by sidewalls 710 of the connecting channel 708. As an example, the sidewalls 710 of the connecting channel 708 may connect to each groove 706A-C at curved junctions 715. In another example, connecting channel 708 may have a width 717, adequately sized to receive a tool for removing magnets mounted in any of the grooves 706A-C. In one example, the width 717 of the connecting channel 708 may be at least 0.3437 inches. Also, the connecting channel 708 may have a length of at least 5.0 inches and a depth of at least 0.3125 inches.

As shown in FIGS. 7B-C, the flat surface 726 and planar surface 728 on the second side of the garment casing may include a plurality of circular markings 732A-C to receive one or more logos. The circular markings 732A-C may have slots 734A-C, respectively formed in a central section of each circular marking. As an example, circular markings 732A-C may have diameters 736A-C sized to fit one or more logos that may be mounted to the garment casing. An example logo 738, may be mounted on a section of the semi-circular portion 705 and linear portion 707 of the garment casing, as shown in FIG. 7C. Although shown with the example logo 738, different logos having sizes may be mounted to the garment casing.

The outer edges 716 of the linear portion 707 of the garment casing may be rounded, for example. In alternative embodiments of the garment casing, the outer edges 716 may have other shapes. The linear portion 707 of the garment casing may have a length 740 and a width 742. The garment casing may have a length, similar to the length 740 of the linear portion 707. As an example, the length 740 of the garment casing may be at least 5.875 inches. Also, the garment casing may have a thickness of at least 0.375 inches. The semi-circular portion 705 may have a width 744, smaller than the length 740 of the linear portion 707. As an example, the width 744 of the semi-circular portion 705 may be at least 3.5 inches. In this way, various sizes of the garment casing may be used in conjunction with a wall member (e.g., wall member 106 shown in FIG. 1A) mounted to a mounting surface, forming a magnetic garment hanger assembly for securely displaying garments of different sizes and weights.

When positioned adjacent to the wall member, the first side of the garment casing may be in facing-sharing contact with a first portion of the garment while the wall member makes face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. For example, the garment casing may be oriented vertically or horizontally when used to secure the garment to the wall member mounted on the mounting surface. As an example, the mounting surface may be a fixed wall or a movable vertical display surface. Although a wall member with a similar shape and size as the garment casing may be used to display the garment, other shapes and sizes of wall members different from the garment casing may be utilized. In this way, the garment casing and wall member may form the magnetic hanger assembly for securely displaying garments while minimizing stress and damage on the garment.

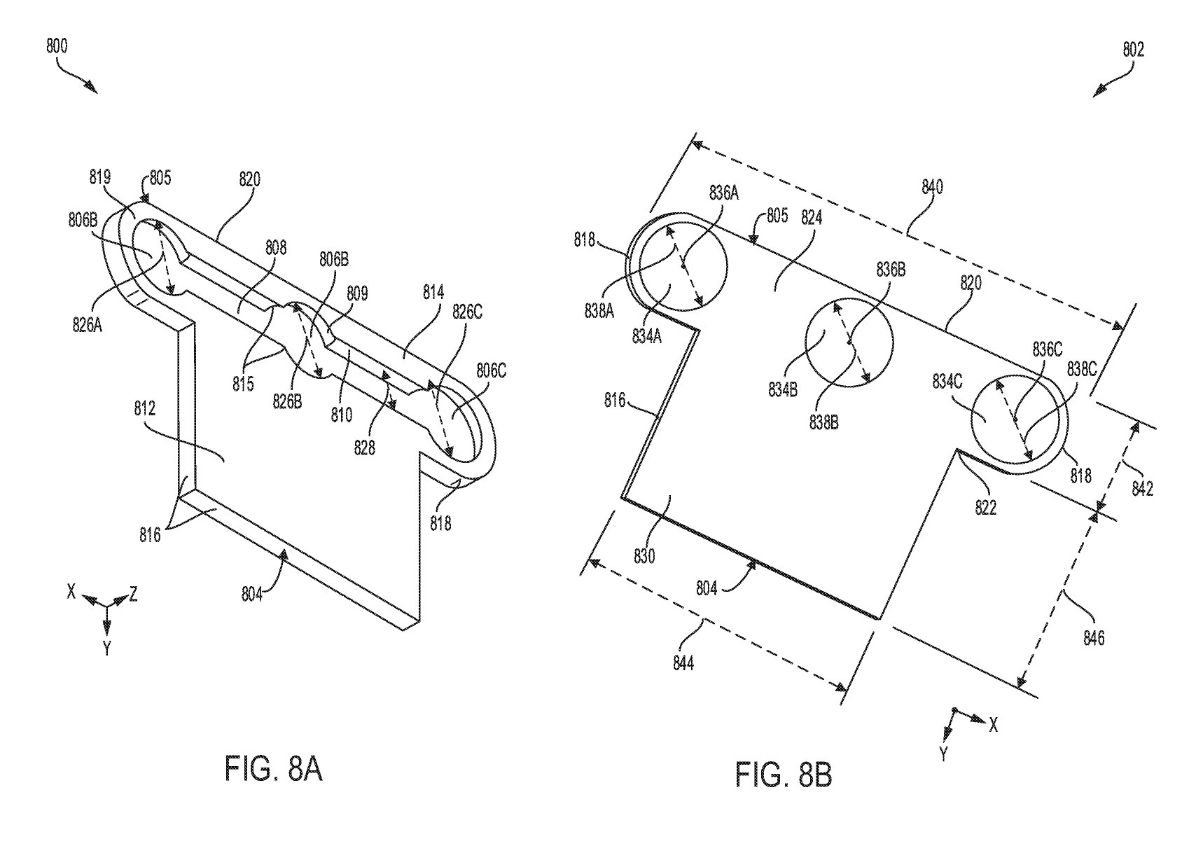

Referring to FIGS. 8A-B, a first view 800 and a second view 802, respectively of a garment casing of a seventh embodiment of a magnetic hanger assembly (such as hanger assembly 104 shown in FIGS. 1A-B) is shown. The magnetic hanger assembly may be used to display an article or a garment (e.g., article 116 or garment 118 shown in FIGS. 1A-B). The garment casing includes a square portion 804 and a linear portion 805. The square portion 804 includes an outer surface 812 and sidewalls 816. The sidewalls 816 of the square portion 804 form an outer boundary of the square portion 804. Similarly, the linear portion 805 includes curved outer edges 818 and a side surface 820 that defines an outer boundary of the linear portion 805. The linear portion 805 joins the square portion 804 at junctions 822. A plurality of grooves 806A-C and connecting channels 808 on the linear portion 805, may be surrounded by the outer surface 812 and planar surface 814 and 819, forming a first side of the garment casing. A second side of the garment casing, comprises a planar surface 824 and flat surface 830, which may be used to display one or more logos.

As shown in FIG. 8A, the grooves 806A-C formed on the garment casing may have diameters 826A-C, each groove 806A-C adequately sized to receive a magnet (e.g., magnet 305 shown in FIGS. 3A-B). As an example, each diameter 826A-C of each groove 806A-C may be at least 0.5 inches. Although shown to have a similar diameter and shape, each groove 806A-C of the garment casing may have a different diameter and shape, thereby allowing the garment casing to retain magnets of different sizes. Each groove 806A-C may have a lip surface 809 configured to securely retain a magnet inside each groove 806A-C. When the magnet is retained inside any of the grooves 806A-C, the lip surface 809 formed by interior walls of each groove 806A-C, may be in face-sharing contact with a circumferential surface of the magnet, thereby retaining the magnet inside any of the grooves 806A-C. Each adjacent pair of grooves 806A-C may be connected to the connecting channel 808 having sidewalls 810. As an example, the connecting channel 808 may transition into each groove 806A-C at curved junctions 815. In another example, the connecting channel 808 may have a width 828, adequately sized to receive a tool for removing magnets from any of the grooves 806A-C. In one example, the width 828 of the connecting channel 808 may be at least 0.3437 inches. Also, the connecting channel 808 may have a length of at least 5.0 inches and a depth of at least 0.3125 inches.

As shown in FIG. 8B, the flat surface 830 and planar surface 832 on the second side of the garment casing may include a plurality of circular markings 834A-C to receive one or more logos. The circular markings 834A-C may have slots 836A-C, respectively formed in a central section of each circular marking. As an example, each circular marking 834A-C may have a diameter 838A-C sized to fit the logo that may be mounted to the garment casing.

The outer edges 818 of the linear portion 805 of the garment casing may be rounded, for example. In alternative embodiments of the garment casing, the outer edges 818 may have other shapes. The linear portion 805 of the garment casing may have a length 840 and a width 842. The garment casing may have a length, similar to the length 840 of the linear portion 805. As an example, the length of the garment casing may be at least 5.875 inches. The square portion 804 may have a length 844 and a width 846. As an example, the length 844 and width 846 of the square portion 804 may be at least 3.5 inches. In this way, various sizes of the garment casing may be used in conjunction with a wall member (e.g., wall member 106 shown in FIG. 1A) mounted to a mounting surface, forming a magnetic hanger assembly for securely displaying garments of different sizes and weights.

When positioned adjacent to the wall member, the first side of the garment casing may be in facing-sharing contact with a first portion of the garment while the wall member makes face-sharing contact with a second portion of the garment. The garment may be secured in between the garment casing and wall member via magnetic adhesion between the garment casing and wall member. For example, the garment casing may be oriented vertically or horizontally when used to secure the garment to the wall member mounted on the mounting surface. As an example, the mounting surface may be a fixed wall or a movable vertical display surface with an adequate area for displaying garments. Although a wall member with a similar shape and size as the garment casing may be used to display the garment, other shapes and sizes of wall members different from the garment casing may be utilized. In this way, the garment casing and wall member may form the magnetic hanger assembly for securely displaying garments of various sizes and weights while minimizing stress exerted on the garments.

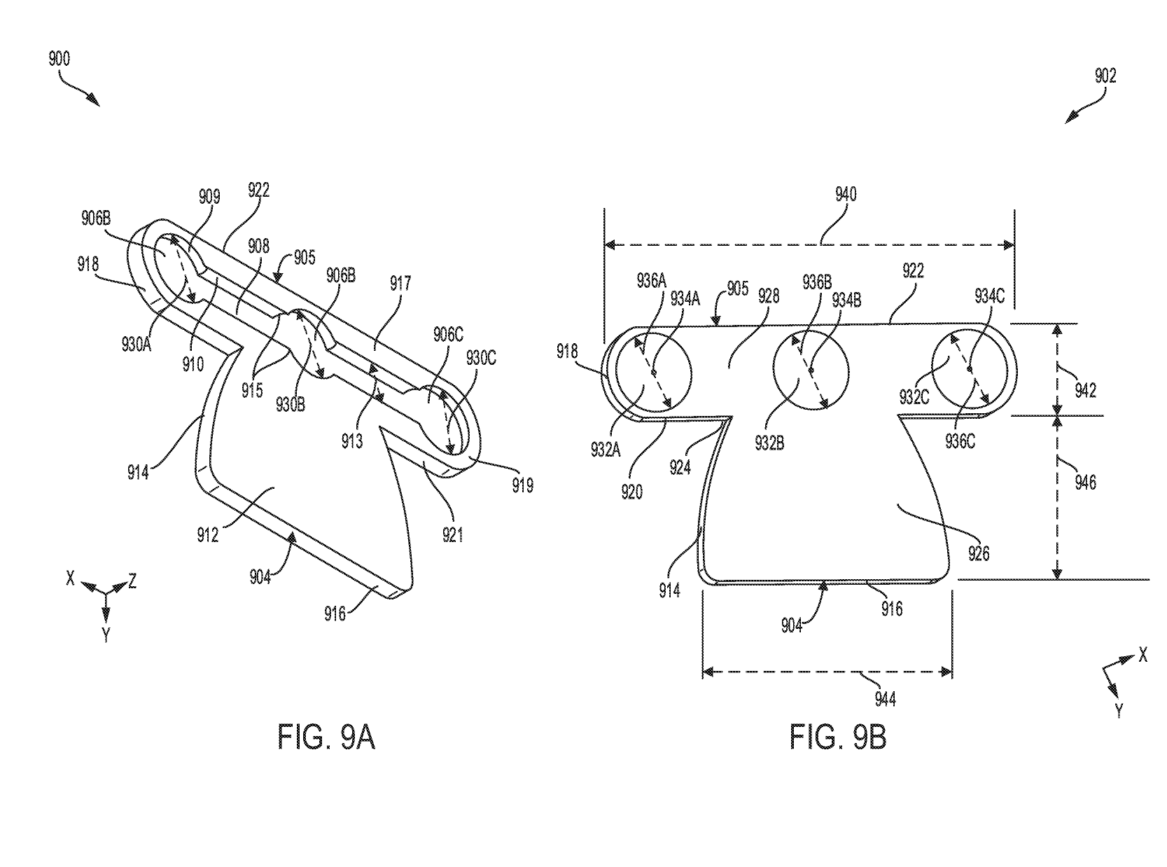

Referring to FIGS. 9A-B, a first view 900 and a second view 902, respectively of a garment casing of an eighth embodiment of a magnetic hanger assembly (such as hanger assembly 104 shown in FIGS. 1A-B) is shown. The garment casing includes a trapezoidal portion 904 and a linear portion 905. The trapezoidal portion 904 includes an outer surface 912, curved sidewall 914 and planar edge 916. The curved sidewall 914 and planar edge 916 of the trapezoidal portion 904 form an outer boundary of the trapezoidal portion. The linear portion 905 includes curved outer edges 918, side edges 920 and a planar edge 922 that defines an outer boundary of the linear portion 905. The side edges 920 of the linear portion 907 join the trapezoidal portion 903 at junctions 924. The linear portion 905 may include a plurality of grooves 906A-C and connecting channels 908, surrounded by the outer surface 912 and planar surfaces 917-919, forming a first side of the garment casing. A second side of the garment casing comprises a flat surface 926 and planar surface 928, which may be used to display one or more logos.

As shown in FIG. 9A, the grooves 906A-C formed on the garment casing may have diameters 930A-C, each groove 906A-C adequately sized to receive a magnet (e.g., magnet 305 shown in FIGS. 3A-B). As an example, each diameter 930A-C of each groove 906A-C may be at least 0.5 inches. Although shown to have a similar diameter and shape, the grooves 906A-C of the garment casing may have different diameters and shapes. In this way, magnets of different sizes and shapes may be mounted in any of the grooves 906A-C of the garment casing. Each groove 906A-C may have a lip surface 909 configured to securely retain the magnet inside each groove 906A-C. The lip surface 909 may have a width of at least 0.03 inches, for example. When the magnet is retained in any of the grooves 906A-C, the lip surface 909 formed by interior walls surrounding each groove 906A-C, may be in face-sharing contact with a circumferential surface of the magnet, thereby retaining the magnet inside each of the grooves 906A-C. Each adjacent pair of grooves 906A-C may be connected to the connecting channels 908 having sidewalls 910. As an example, the connecting channels 908 may connect to each groove 906A-C at curved junctions 915. In another example, connecting channels 908 may have a width 913, adequately sized to receive a tool for removing magnets from any of the grooves 906A-C. In one example, the width 913 of the connecting channel 908 may be smaller than each diameter 930A-C of each groove 906A-C, and may be at least 0.3437 inches. Also, the connecting channel 908 may have a length of at least 5.0 inches and a depth of at least 0.3125 inches.

As shown in FIG. 9B, the flat surface 926 and planar surface 928 on the second side of the garment casing may include a plurality of circular markings 932A-C to receive one or more logos. The circular markings 932A-C may have slots 934A-C, respectively formed in a central section of each circular marking. As an example, the circular marking 932A-C may have diameters 936A-C, respectively sized to fit the logo that may be mounted to the garment casing.

The outer edges 918 of the linear portion 905 of the garment casing may be rounded, for example. In alternative embodiments of the garment casing, the outer edges 918 may have other shapes. The linear portion 905 may have a length 940 and a width 942. The garment casing may have a length, similar to the length 940 of the linear portion 905. As an example, the length of the garment casing may be at least 5.875 inches. The width 942 of the linear portion 905 may be at least 1.0 inches. The trapezoidal portion 904 may have a length 944 and width 946. As an example, the length 944 and width 946 of the trapezoidal portion 904 may be at least 3.5 inches and 2.5 inches, respectively. In this way, various sizes of the garment casing may be used in conjunction with a wall member (such as wall member 106 shown in FIG. 1A) attached to a mounting surface, forming the magnetic hanger assembly for securely displaying garments of different sizes and weights.

When positioned adjacent to the wall member attached to the mounting surface, the first side of the garment casing may be in facing-sharing contact with a first portion of the garment while the wall member makes face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. For example, the garment casing may be oriented vertically or horizontally when used to secure the garment to the wall member mounted on the mounting surface. As an example, the mounting surface may be a fixed wall or a movable vertical display surface with adequate area for displaying one or more garments. Although a wall member with a similar shape and size as the garment casing may be used to display the garment, other shapes and sizes of wall members different from the garment casing may be utilized. In this way, the garment casing and wall member may form the magnetic hanger assembly used for securely displaying garments of various shapes and weights while minimizing stress exerted on the garment.

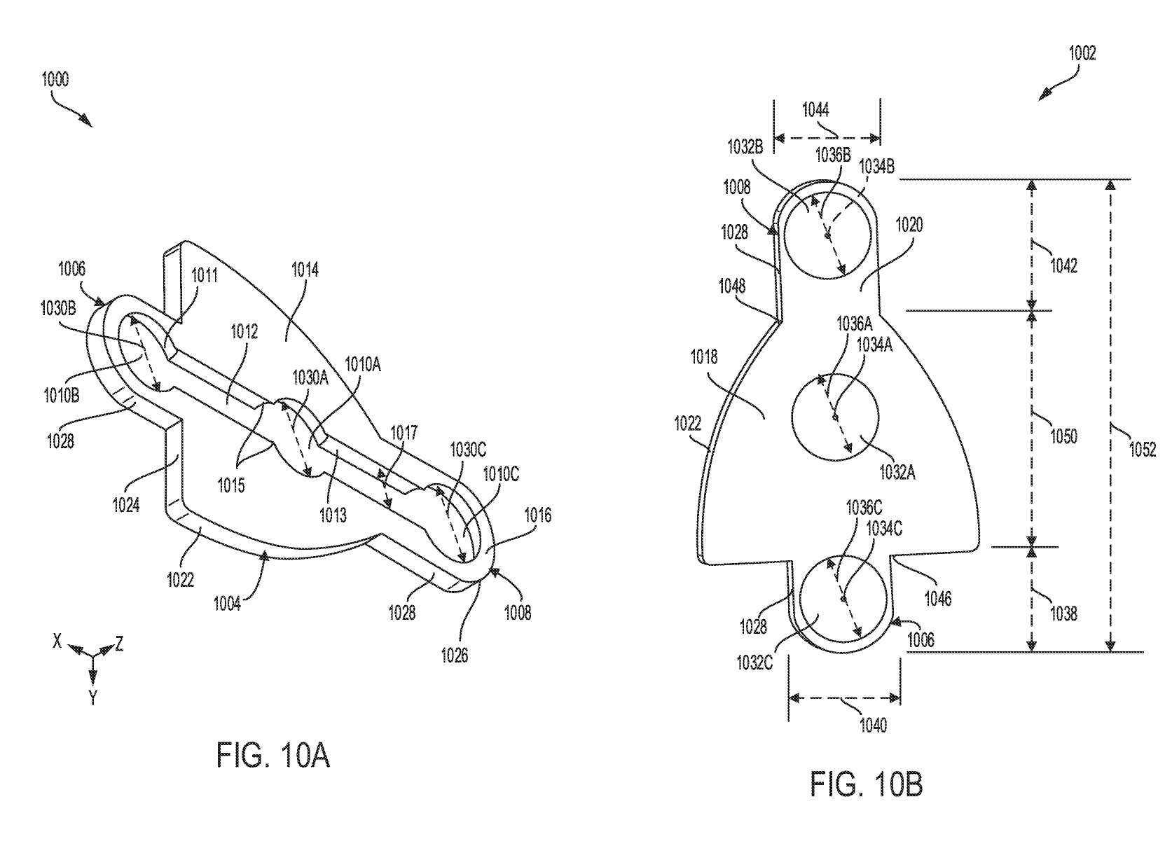

Referring to FIGS. 10A-B, a first view 1000 and a second view 1002, respectively of a garment casing of a ninth embodiment of a magnetic hanger assembly (such as hanger assembly 104 shown in FIG. 1A) is shown. Although not shown, the magnetic hanger assembly may include a wall member (e.g., wall member 106 shown in FIG. 1A) that may be used in conjunction with the garment casing to display a garment (e.g., garment 118 shown in FIG. 1B). The garment casing includes a truncated oval portion 1004 with a first extended portion 1006 and a second extended portion 1008.

As shown in FIG. 10A, the truncated oval portion 1004 includes a groove 1010A and connecting channels 1012, surrounded by an outer surface 1014. The first and second extended portions 1006 and 1008 of the garment casing may include grooves 1010B-C, respectively connected to the connecting channels 1012, and surrounded by a planar surface 1016. The grooves 1010A-C, connecting channel 1012, outer surface 1014 and planar surface 1016 may form a first side of the garment casing. A second side of the garment casing, comprises a flat surface 1018 and planar surface 1020, which may be used to display one or more logos. The truncated oval portion 1004 of the garment casing may further include curved side walls 1022 and planar edges 1024, which form an outer boundary of the truncated oval portion 1004. Each of the first and second extended portions 1006 and 1008 include a curved outer edge 1026 and side edge 1028 that defines an outer boundary of each extended portion.

The grooves 1010A-C formed on the first side of the garment casing may have diameters 1030A-C, each groove 1006A-C adequately sized to receive a magnet (e.g., magnet 305 shown in FIGS. 3A-B). As an example, each diameter 1030A-C of each groove 1006A-C may be at least 0.5 inches. Although shown to have a similar diameter and shape, the grooves 1010A-C of the garment casing may be sized with different diameters and shapes. In this way, magnets of different sizes and shapes may be mounted in any of the grooves 1010A-C of the garment casing. Each groove 1010A-C may have a lip surface 1011 configured to securely retain the magnet inside each groove 1010A-C. When the magnet is retained inside any of the grooves 1006A-C of the garment casing, the lip surface 1011 formed by interior walls surrounding each groove 1010A-C, may be in face-sharing contact with a circumferential surface of the magnet, thereby retaining the magnet inside the grooves 1010A-C. Each adjacent pair of grooves 1010A-C may be connected to the connecting channel 1012 having sidewalls 1013. As an example, the connecting channels 1012 may connect to each groove 1010A-C at curved junctions 1015. In another example, connecting channels 1012 may have a width 1017, adequately sized to receive a tool for removing magnets mounted inside any of the grooves 1010A-C. In one example, the width 1017 of the connecting channels 1012 may be at least 0.3437 inches. Also, the connecting channel 1012 may have a length of at least 5.0 inches and a depth of at least 0.3125 inches.

The flat surface 1018 and planar surface 1020 on the second side of the garment casing may include a plurality of markings 1032A-C having apertures 1034A-C, respectively. The markings 1032A-C, may have diameters 1036A-C, respectively. As an example, the diameters 1036A-C of the markings 1032A-C, may be adequately sized to receive one or more logos.

The outer edges 1026 of each of the first and second extended portions of the garment casing may be rounded, for example. In alternative embodiments, the outer edges 1026 of the garment casing may have other shapes. The first extended portion 1006 of the garment casing may have a length 1038 and a width 1040. Similarly, the second extended portion 1008 of the garment casing may have a length 1042 and a width 1044. As an example, the width and length of each of the first and second extended portions may be selected to accommodate a groove adequately sized to receive a magnet in each extended portion. The first and second extended portions join the truncated oval portion 1004 at junctions 1046 and 1048, respectively. The truncated oval portion 1004 may have a length 1050, larger than the length 1042 of the second extended portion 1008. As an example, the length 1050 of the truncated oval portion 1004 may be at least 3.0 inches. The truncated oval portion 1004 may have a width of at least 3.5 inches. The garment casing may have a length 1052, larger than the length 1050 of the truncated oval portion 1004. As an example, the length 1052 of the garment casing may be at least 5.875 inches. In this way, various sizes of the garment casing may be used in conjunction with the wall member, such as the wall member 106 shown in FIG. 1A, forming a magnetic hanger assembly for securely displaying garments on the mounting surface.

When positioned adjacent to the wall member attached to a mounting surface, the first side of the garment casing may be in facing-sharing contact with a first portion of the garment, and the wall member may be in face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. For example, the garment casing may be oriented vertically or horizontally when used to display the garment. Although a wall member with a similar shape and size as the garment casing may be used to display the garment, wall members with different shapes and sizes may be utilized. In this way, the garment casing and wall member may form the magnetic hanger assembly for adequately displaying garments of various shapes and weights while minimizing stress exerted on the garment.

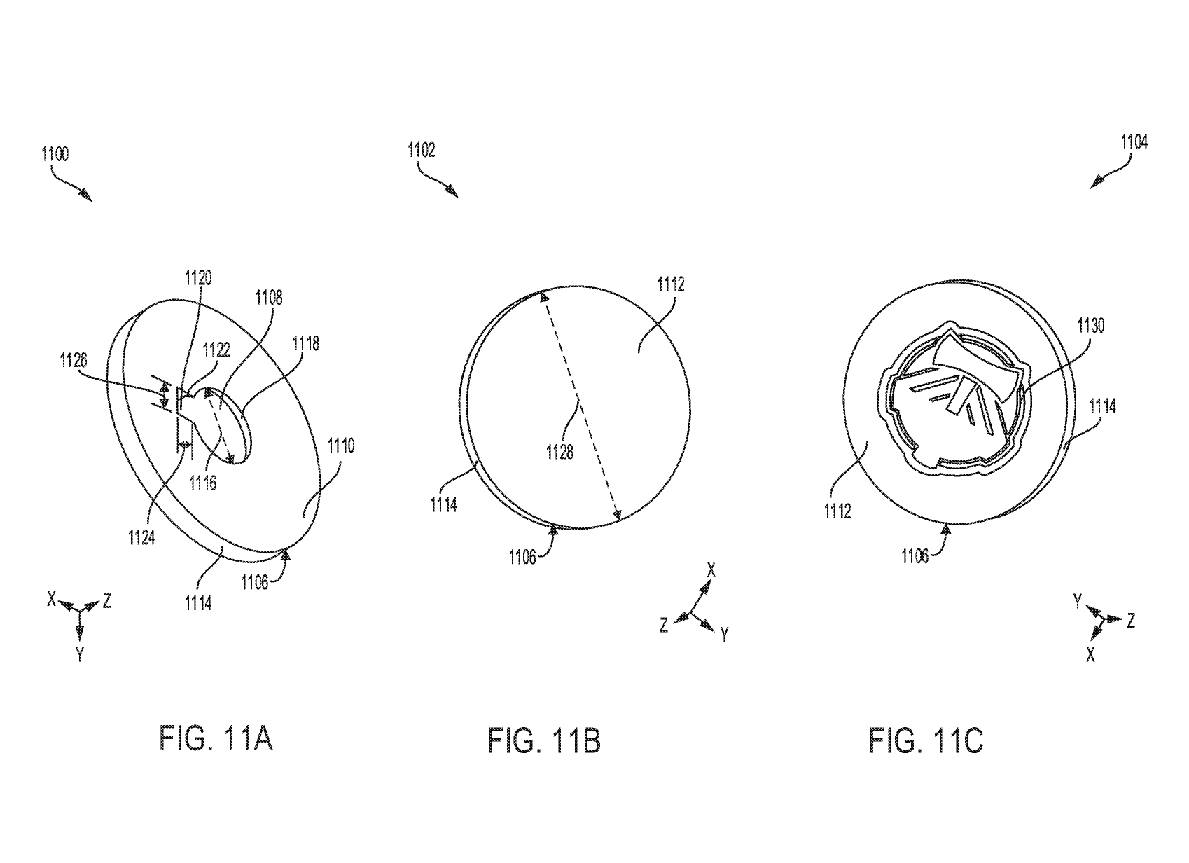

Referring to FIGS. 11A-C, a first view 1100, a second view 1102 and a third view 1104, respectively of a garment casing 1106 of a tenth embodiment of a magnetic hanger assembly (such as hanger assembly 104 shown in FIG. 1A) is shown. The garment casing 1106 includes a groove 1108 surrounded by a raised outer surface 1110. The groove 1108 and raised outer surface 1110 from a first side of the garment casing 1106. A flat surface 1112 forms a second side, opposite to the first side of the garment casing 1106. A sidewall 1114 of the garment casing 1106 forms an outer boundary of the garment casing.

As shown in FIG. 11A, the groove 1108 formed on the garment casing 1106 may have a diameter 1116. The groove 1108 may be adequately sized to receive a magnet, such as the magnet 305 shown in FIGS. 3A-B. The diameter 1116 of the groove 1108 may be at least 0.5 inches. The groove 1108 may have a lip surface 1118 configured to securely retain the magnet in the groove 1108. The lip surface 1118 may have a width of at least 0.03 inches, for example. When the magnet is disposed in the groove 1108, the lip surface 1118 of the groove 1108 may be in face-sharing contact with a perimeter of the magnet, thereby retaining the magnet in the groove 1108. Although shown to have a circular shape, the groove 1108 of the garment casing 1106 may have different shapes. In this way, the garment casing 1106 may be configured to retain magnets of different sizes and shapes.

Further, the groove 1108 may be connected to a recessed slot 1120 having sidewalls 1122. The recessed slot 1120 may be adequately sized to receive a tool for removing the magnet from the groove 1108. As an example, the recessed slot 1120 may have a length 1124 and a width 1126, smaller than the diameter 1116 of the groove 1108. In one example, the length 1124 and width 1126 may be at least 0.03 inches and 0.04 inches, respectively.

As shown in FIGS. 11B-C, the flat surface 1112 may be adequately sized to receive one or more logos. As an example, the flat surface 1112 may have a diameter 1128 of at least 3.5 inches. An example logo 1130, may be mounted on the flat surface 1112, as shown in FIG. 11C. Although shown with the example logo 1130, various logos having different sizes may be secured on the garment casing 1106. The garment casing 1106 may have a similar range of diameters as the diameter 1128 of the flat surface 1112. The garment casing 1106 may have a thickness of at least 0.375 inches. In this way, various sizes of the garment casing 1106 may be used in conjunction with a wall member (e.g., wall member 106 shown in FIGS. 1A-B) mounted to a mounting surface, forming a magnetic garment hanger assembly for adequately displaying garments of different shapes and weights.

When positioned adjacent to the wall member, the first side of the garment casing 1106 may be in facing-sharing contact with a first portion of the garment while the wall member makes face-sharing contact with a second portion of the garment. The garment casing and wall member of the magnetic hanger assembly may be held together securely by magnetic attraction forces. The garment may be secured in between the garment casing and wall member via magnetic adhesion between the garment casing and wall member. For example, the garment casing 1106 may be oriented vertically or horizontally when secured to the garment to the wall member mounted on the mounting surface. Although a wall member with a similar shape and size as the garment casing 1106 may be used to display the garment, other shapes and sizes of wall members may be utilized. In this way, the garment casing 1106 and wall member may form the magnetic hanger assembly for securely displaying garments of various shapes and weights while minimizing stress and damage on the garments.

Referring to FIG. 12, a schematic view of a garment display 1200 using the second embodiment of the garment hanger assembly is shown. The garment display 1200 includes a first type of garment 1202 mounted to a mounting surface 1204 using a first garment casing 1206 and a second casing 1208. The first and second garment casings 1206 and 1208, may have similar shapes and sizes as the garment casings disclosed with reference to FIGS. 2A-3C. Although not shown, a first and a second wall member (such as wall member 106 shown in FIGS. 1A-B), may be mounted between the garment 1202 and the mounting surface 1204, directly upstream of the first and second garment casing, respectively. The wall members may be mounted to the mounting surface using suitable fasteners such as screws or bolts or other means of mechanical assembly.

As shown in FIG. 12, the garment 1202 may be displayed on the mounting surface 1204 by positioning the first garment casing 1206 at a first location, and positioning the second garment casing 1208 at a second location, different from the first location. Each of the first and second garment casing may have at least one magnet mounted in grooves (e.g., grooves 206A-C shown in FIG. 2A) in each casing. The first and second wall members of the garment hanger assembly may each have a magnetic surface. As an example, the first and second wall members may be comprised of magnetic material, such as iron, steel, nickel or other suitable ferromagnetic materials. The garment casings and wall members of the magnetic hanger assembly may be held together securely by magnetic attraction forces. When positioned, the garment 1202 may be held in between the garment casings and wall members via magnetic adhesion. The first garment casing 1206 and the second garment casing 1208 may be in face-sharing contact with an outer surface 1210 of the garment 1202, while the first and second wall members may be in face-sharing contact with an inner surface (not shown) of the garment 1202. The first and second garment casings may be positioned on the outer surface 1210 of the garment 1202, and the inner surface of the garment may be in direct contact with the mounting surface 1204. For example, the mounting surface 1204 may be a fixed wall or a movable vertical display surface. In one example, the mounting surface 1204 may be comprised of magnetic material such as cast iron, stainless steel and other suitable materials, thereby allowing the garment 1202 to be securely displayed with or without use of the wall members. In other examples, the first and second garment casings 1206 and 1208 may be positioned on the outer surface 1210 of the garment 1202 along a first axis 1212 and a second axis 1214, respectively. In one example, a portion of each of the first and second garment casing may lie along a third axis 1216. In other examples, the first and second casings may be positioned on the garment 1202, with the first garment casing 1206 placed at a distance 1220 from the second garment casing 1208. In one example, the distance 1220 between the first and second garment casing may be at least 6.0 inches. Although shown mounted along axes 1212 and 1214, the first and second garment casings may be placed at other positions that allow garment 1202 to be adequately displayed without obstruction, for example. In alternative examples two or more magnets with similar or different configuration may be retained inside the first and second garment casing, and used in conjunction with the first and second wall members, respectively to display the garment 1202. In this way, magnets having various sizes and shapes may be used in conjunction with a plurality of wall members to adequately display the garment 1202, while minimizing damage to the garment.

Referring to FIGS. 13A-B, a schematic view of a first garment display 1300 and a second garment display 1302, respectively is shown. The first garment display 1300 utilizes the second embodiment of the garment hanger assembly, and the second garment display 1302 utilizes the tenth embodiment of the garment hanger assembly for displaying a second type of garment 1308. The garment display 1300 includes a first garment casing 1304 and a second casing 1306 positioned on the garment 1308 displayed on a mounting surface 1310. The first and second garment casings 1304 and 1306, may be similar to the garment casing 204 disclosed with reference to FIGS. 2A-B. The garment display 1302 includes the garment 1308 secured to the mounting surface 1310 using a third garment casing 1322 and a fourth casing 1324. The third and fourth garment casings 1322 and 1324, may be similar to the garment casing 1106 disclosed with reference to FIGS. 11A-C. Each of the first and second garment displays may include two or more magnets (e.g., magnet 305 shown in FIGS. 3A-B) mounted to each of the first, second, third and fourth garment casings. Although not shown, wall members (such as wall member 106 shown in FIG. 1A) having magnetic surfaces, may be mounted between the garment 1308 and the mounting surface 1310, directly upstream of each garment casings 1304, 1306, 1322 and 1324.

As shown in FIG. 13A, the garment 1308 may be displayed on the mounting surface 1310 by positioning the first garment casing 1304 at a first location, and positioning the second garment 1306 at a second location. Each of the first and second garment casing may have at least one magnet mounted in grooves (e.g., grooves 206A-C shown in FIG. 2A) in each casing. Corresponding wall members of the garment hanger assembly in display 1300 may each have a magnetic surface. As an example, the wall members may be comprised of magnetic material, such as iron, steel, nickel or other suitable ferromagnetic materials. The garment casings and wall members of the magnetic hanger assembly may be held together securely by magnetic attraction forces. When positioned, the first garment casing 1304 and the second garment casing 1306 may be in face-sharing contact with an outer surface 1330 of the garment 1308, while the corresponding wall members may be in face-sharing contact with an inner surface (not shown) of the garment 1308. The garment 1308 may be securely held in between the garment casings and wall members in display 1300 via magnetic adhesion. In another example, the first and second garment casings may be positioned on the outer surface 1330 of the garment 1308, while the inner surface of the garment 1308 may be in direct contact with the mounting surface 1310. In other examples, the first and second garment casings 1304 and 1306 may be positioned on the outer surface 1330 of the garment 1308 along a first axis 1314 and a second axis 1316, respectively. In one example, a portion of each of the first and second garment casings may lie along a third axis 1318 and fourth axis 1320, respectively. Although shown positioned along axes 1314 and 1316, the first and second garment casings may be positioned at other positions that allow garment 1308 to be adequately displayed without obstruction, for example. In alternative examples two or more magnets with similar or different configuration may be retained inside the first and second garment casing 1304 and 1306, and used in conjunction with corresponding wall members to display the garment 1308. In this way, magnets having various sizes and shapes may be used in conjunction with a plurality of wall members to adequately display the garment 1308, while minimizing stress exerted on the garment.

As shown in FIG. 13B, the garment 1308 may be displayed on the mounting surface 1310 by positioning the third garment casing 1322 at a third location 1326, and positioning the fourth garment casing 1324 at a fourth location 1312. Each of the third and fourth garment casings may have at least one magnet mounted in a groove (e.g., groove 1108 shown in FIG. 11A) in each casing. Corresponding wall members of the garment hanger assembly in the display 1302 may each have a magnetic surface. When positioned, the third garment casing 1322 and the fourth garment casing 1324 may be in face-sharing contact with the outer surface 1330 of the garment 1308, while the corresponding wall members may be in face-sharing contact with the inner surface of the garment 1308. The garment 1308 may be securely held in between the garment casings and corresponding wall members in the display 1302 via magnetic adhesion. In another example, the third and fourth garment casings may be positioned on the outer surface 1330 of the garment 1308, while the inner surface of the garment 1308 may be in direct contact with the mounting surface 1310. When positioned to the outer surface 1330 of the garment 1308, the third and fourth garment casings 1322 and 1324 may be aligned along a fifth axis 1332 and a sixth axis 1334, respectively. In one example, a portion of each of the third and fourth garment casings may lie along a seventh axis 1336. In alternative examples, the third and fourth garment casings may be positioned at other positions that allow garment 1308 to be adequately displayed without obstruction. In further examples a magnet with a similar or different configuration may be retained in each of the third and fourth garment casing 1322 and 1324, and used in conjunction with the corresponding wall members to display the garment 1308. In this way, garment casings having magnets of various sizes and shapes may be used in conjunction with a plurality of wall members to adequately display the garment 1308, while minimizing damage to the garment.

Referring now to FIG. 14, an example method 1400 is shown for displaying a garment on a mounting surface (e.g., mounting surface 110 shown in FIGS. 1A-B) using a garment hanger assembly disclosed with reference to FIGS. 1A and 12-13 using components disclosed at FIGS. 2A-11C. The garment hanger assembly may include a wall member (e.g., wall member 106 shown in FIG. 1A) and a garment casing, such as the garment casing 108 shown in FIGS. 1A-B.

At 1402, method 1400 may include mounting the wall member to the mounting surface using a fastener. As an example, the wall member may be mounted to the mounting surface, using a screw or a bolt and nut assembly or other suitable means of mechanical assembly. In one example, the wall member may be mounted to the mounting surface, with an inner face of the wall member in face-sharing contact with the mounting surface, and an outer face of the wall member facing away from the mounting surface. The outer face of the wall member may include a magnetic surface that is attracted to a magnet. In one example, the magnetic surface may comprise of materials such as iron, steel, nickel or a suitable ferromagnetic materials. In other examples, two or more wall members may be mounted to the mounting surface via a plurality of fasteners. In one example, a first and a second wall member, may be mounted to the mounting surface, with the first wall member positioned at a first distance from the second wall member. The mounting surface may be a fixed or a movable vertical display surface with a large area for displaying one or more garments, for example.

At 1404, method 1400 may include positioning a garment on the wall member mounted to the mounting surface. The garment may be positioned on the wall member, such that an inner surface of the garment is in face-sharing contact with the outer face of the wall member, and an outer surface of the garment may face outward and away from the wall member. In the example where two or more wall members are mounted to the mounting surface, the garment may be positioned such that the inner surface of the garment makes face contact with outer surface of each wall member.

At 1406, method 1400 may include positioning a garment casing on the garment. The garment casing may include a first face having a plurality of grooves containing at least one magnet, and a second face having a flat surface, the second face formed opposite to the first face. Each groove of the garment casing, may be configured with an internal lip surface (such as lip surface 209 shown in FIG. 2A) to retain a magnet disposed inside the groove. As an example, the garment casing may be positioned on the outer surface of the garment at a position directly upstream and adjacent to the wall member, with the first face of the garment casing in face-sharing contact with the outer surface of the garment, and the second face of the garment casing facing outward and away from the garment. The garment casing may be held in place by magnetic adhesion between the garment casing and wall member, for example. The garment casing may be a flat molded plate comprised of a non-magnetic material such as plastic, wood, glass or suitable materials for example.

In alternative examples, a portion of the garment casing may be comprised of magnetic materials. In one example, an interior region of the garment casing including the grooves, may comprise of magnetic materials, thereby allowing one or more magnets to be retained in any of the grooves via magnetic interaction between the magnet and garment casing. In further examples, a first and a second garment casing may be positioned on the garment, with the first garment casing placed directly opposite and adjacent to the first wall member, and second garment casing positioned directly opposite and adjacent to the second wall member; the first and second garment casings spaced at a second distance.

At 1408, method 1400 may include securing the garment in between the wall member and garment casing via magnetic adhesion between the wall member and garment casing. In this case, the inner surface of the garment may be in face-sharing contact with the wall member while the outer surface of the garment may be in face-sharing contact with the garment casing, with the second side facing outward and away from the garment. When positioned on the garment, the garment casing may be removable while the wall member may be fixed to the mounting surface. The garment casing may be removed from one position and placed at another position on the garment that allows for adequate display of the garment with minimal obstruction or damage.

In alternative embodiments, two or more garment hanger assemblies may be used to secure the garment, each garment assembly may be positioned at a suitable distance from a preceding or succeeding garment hanger assembly to allow unobstructed display of the garment. Each garment hanger assembly may include a wall member secured to the mounting surface, and a garment casing positioned on the garment secured between the wall member and garment casing. As an example, each garment casing of the each garment hanger assembly may include one or more magnets, having different sizes and magnetic properties. In one example, magnets having adequate magnetic strengths may be used to securely display garments having different weights. In this way, one or more garment hanger assemblies may be used to adequately display garments of various weights while minimizing damage to the garments. The method 1400 proceeds to exit.

As an example, a garment hanger assembly kit comprising a plurality of wall members, garment casings, magnets, fasteners, and instructions for assembly the garment hanger assembly may be procured may be provided. The instructions may include schematic drawings of different components of the assembly and directions on how to assemble the components of the assembly together, to securely display garments on the mounting surface, for example. In one example, the instructions may include assembly specifications such as spacing between each pair of wall member and garment casing, correlation between magnetic strength and garment weight, and other details.

In one example, garment hanger assembly comprises: a first member having a plurality of grooves for retaining at least one removable magnet, a second member having a magnetic adhesion surface and mounted to a mounting surface via a fastener, wherein the first and the second member are coupled together via magnetic adhesion to retain a garment in a display position; further wherein the first member is mounted on a first side of the garment and the second member is mounted on a second side of the garment, the garment disposed therebetween and in face-sharing contact with the first and second member.

In the preceding example, additionally or optionally, the grooves are spaced evenly along a connecting channel of the first member. In any or all of the preceding examples, additionally or optionally, each groove has an internal lip surface to retain the magnet within the groove. In any or all of the preceding examples, additionally or optionally, the first member is comprised of a non-magnetic material and the second member is comprised of a magnetic material. In any or all of the preceding examples, additionally or optionally, the second member has a similar size and shape as the first member. In any or all of the preceding examples, additionally or optionally, the shape of the first and second member is linear. In any or all of the preceding examples, additionally or optionally, the shape of the first member includes a square portion having a first and a second extended arm. In any or all of the preceding examples, additionally or optionally, the first and second member are comprised of a magnetic material. In any or all of the preceding examples, additionally or optionally, the second member has a different size and shape from the first member. In any or all of the preceding examples, additionally or optionally, the mounting surface is a fixed surface or a movable vertical display surface.

An example method for displaying a garment on a mounting surface comprises: mounting a wall member having a magnetic surface to the mounting surface via a fastener; positioning the garment on the wall member such that an inner surface of the garment faces the wall member, and an outer surface of the garment faces outward and away from the wall member; positioning a garment casing having at least one magnet, on the outer surface of the garment at a position directly upstream and adjacent to the wall member; and securing the garment between the wall member and garment casing using magnetic adhesion between the wall member and garment casing, the garment making contact with the wall member and garment casing; wherein the wall member has an inner face that is in face-sharing contact with the mounting surface, and an outer face that makes contact with the inner surface of the garment; wherein the garment casing has a first side that is in face-sharing contact with the outer surface of the garment, and a second side that faces outward and away from the garment; wherein the garment casing is removable and the wall member is fixed to the mounting surface.

In the preceding example, the fastener for mounting the wall member to the mounting surface includes a screw or a bolt and nut assembly. In any or all of the preceding examples, additionally or optionally, the garment casing includes a first, a second and a third groove formed on the first side of the garment casing; each groove spaced evenly along a connecting channel. In any or all of the preceding examples, additionally or optionally, the first and third grooves contain a first and a second magnet, respectively. In any or all of the preceding examples, additionally or optionally, the second side of the garment casing includes a logo.

An example system for displaying a garment on a mounting surface comprises: a first garment hanger assembly positioned at a first location on the garment and a second garment hanger assembly positioned at a second location on the garment, wherein the first garment assembly includes a first wall member and a first garment casing, and the second garment assembly includes a second wall member and a second garment casing; wherein the first and second wall members are mounted to the mounting surface via a plurality of fasteners, each wall member having a magnetic surface; wherein the first garment casing is positioned directly opposite and adjacent to the first wall member, and the second garment casing is positioned directly opposite and adjacent to the second wall member, each of the first and second garment casings having at least one magnet; wherein the garment is secured between the first garment casing and first wall member at the first position via magnetic interaction between the first garment casing and first wall member, and secured between the second garment casing and second wall member at the second location via magnetic interaction between the second garment casing and second wall member.

In any or all of the preceding examples, additionally or optionally, the first garment hanger assembly is similar to the second garment hanger assembly. In any or all of the preceding examples, additionally or optionally, each of the first and second garment casings have similar shapes as each of the first and second wall members. In any or all of the preceding examples, additionally or optionally, the shapes of the first and second garment casings are circular. In any or all of the preceding examples, additionally or optionally, the garment is displayed in a vertical or horizontal direction.

It should be noted that the magnetic hanger assembly embodiments provided herein may be used in a manner in which the garment casing of the hanger assembly is the same shape as the wall member of the assembly as well as well as in instances where the garment casing and wall member of the hanger assembly are substantially different shapes.

In some embodiments, the garment casing of the magnetic hanger assembly may be decorated with different logos for example, or illustrated with other graphics that supplement the aesthetic appearance of the garment to be displayed.

It will be appreciated that the configurations and methods disclosed herein are exemplary in nature, and that these specific embodiments are not to be considered in a limiting sense, because numerous variations are possible. For example, the above technology may be applied to different shapes and sizes of magnetic hanger assemblies. The subject matter of the present disclosure includes all novel and non-obvious combinations and sub-combinations of the various assemblies, methods, and properties disclosed herein.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

Embodiments of a magnetic hanger assembly have been described. This written description uses examples to disclose the invention, including the best mode, and also to enable a person of ordinary skill in the relevant art to practice the invention, including making and using any devices or systems and performing any incorporated methods. Applicant reserves the right to submit claims and amend claims to the invention. The examples are intended to be within the scope of the claims if they have structural elements that do not differ from the literal language of the claims, or if they include equivalent structural elements with insubstantial differences from the literal languages of the claims or future claims.

1. A garment hanger assembly comprising:
a first member having a plurality of grooves for retaining at least one removable magnet, a second member having a magnetic adhesion surface and mounted to a mounting surface via a fastener,
wherein the first and the second member are coupled together via magnetic adhesion to retain a garment in a display position;
further wherein the first member is mounted on a first side of the garment and the second member is mounted on a second side of the garment,
the garment disposed therebetween and in face-sharing contact with the first and second member.

2. The garment hanger of claim 1, wherein the grooves are spaced evenly along a connecting channel of the first member.

3. The garment hanger assembly of claim 1, wherein each groove has an internal lip surface to retain the magnet within the groove.

4. The garment hanger assembly of claim 1, wherein the first member is comprised of a non-magnetic material and the second member is comprised of a magnetic material.

5. The garment hanger assembly of claim 1, wherein the second member has a similar size and shape as the first member.

6. The garment hanger assembly of claim 5, wherein the shape of the first and second member is linear.

7. The garment hanger assembly of claim 5, wherein the shape of the first member includes a square portion having a first and a second extended arm.

8. The garment hanger assembly of claim 1, wherein the first and second member are comprised of a magnetic material.

9. The garment hanger assembly of claim 8, wherein the second member has a different size and shape from the first member.

10. The garment hanger assembly of claim 1, wherein the mounting surface is a fixed surface or a movable vertical display surface.

11. A method for displaying a garment on a mounting surface comprising:
mounting a wall member having a magnetic surface to the mounting surface via a fastener;
positioning the garment on the wall member such that an inner surface of the garment faces the wall member, and an outer surface of the garment faces outward and away from the wall member;
positioning a garment casing having at least one magnet, on the outer surface of the garment at a position directly upstream and adjacent to the wall member;
and securing the garment between the wall member and garment casing using magnetic adhesion between the wall member and garment casing, the garment making contact with the wall member and garment casing;
wherein the wall member has an inner face that is in face-sharing contact with the mounting surface, and an outer face that makes contact with the inner surface of the garment;
wherein the garment casing has a first side that is in face-sharing contact with the outer surface of the garment, and a second side that faces outward and away from the garment;
wherein the garment casing is removable and the wall member is fixed to the mounting surface.

12. The method of claim 11, wherein the fastener for mounting the wall member to the mounting surface includes a screw or a bolt and nut assembly.

13. The method of claim 11, wherein the garment casing includes a first, a second and a third groove formed on the first side of the garment casing; each groove spaced evenly along a connecting channel.

14. The method of claim 13, wherein the first and third grooves contain a first and a second magnet, respectively.

15. The method of claim 11, wherein the second side of the garment casing includes a logo.

16. A system for displaying a garment on a mounting surface comprising: a first garment hanger assembly positioned at a first location on the garment and a second garment hanger assembly positioned at a second location on the garment, wherein the first garment assembly includes a first wall member and a first garment casing, and the second garment assembly includes a second wall member and a second garment casing;
wherein the first and second wall members are mounted to the mounting surface via a plurality of fasteners, each wall member having a magnetic surface;
wherein the first garment casing is positioned directly opposite and adjacent to the first wall member, and the second garment casing is positioned directly opposite and adjacent to the second wall member, each of the first and second garment casings having at least one magnet;
wherein the garment is secured between the first garment casing and first wall member at the first position via magnetic interaction between the first garment casing and first wall member, and secured between the second garment casing and second wall member at the second location via magnetic interaction between the second garment casing and second wall member.

17. The system of claim 16, wherein the first garment hanger assembly is similar to the second garment hanger assembly.

18. The system of claim 16, wherein each of the first and second garment casings have similar shapes as each of the first and second wall members.

19. The system of claim 18, wherein the shapes of the first and second garment casings are circular.

20. The system of claim 16, wherein the garment is displayed in a vertical or horizontal direction.
